(19) United States
(12) Patent Application Publication
(10) Pub. No.: US 2022/0256218 A1
(43) Pub. Date: Aug. 11, 2022

(54) Content-Modification System With Feature For Exposing Multiple Devices In A Household To The Same Or Similar Advertisements

(71) Applicant: Roku, Inc., San Jose, CA (US)

(72) Inventor: Matthew Grover, Cardiff (GB)

(21) Appl. No.: 17/343,310

(22) Filed: Jun. 9, 2021

Related U.S. Application Data
(60) Provisional application No. 63/148,220, filed on Feb. 11, 2021.

(51) Int. Cl. H04N 21/258; H04N 21/81; H04N 21/234; H04N 21/24

(52) U.S. Cl. CPC H04N 21/25883; H04N 21/812; H04N 21/2407; H04N 21/25891; H04N 21/23424

(57) ABSTRACT

In one aspect, a method includes identifying a group of content-presentation devices that are associated with the same household. The method also includes determining that a first content-presentation device of the identified group has received a first advertisement segment. The method also includes identifying a second content-presentation device of the identified group, different from the first content-presentation device, that is tuned to a content-modification-enabled channel that supports performance of content-modification operations. The method also includes causing a replacement advertisement segment associated with the first advertisement segment to be transmitted to the second content-presentation device for output by the second content-presentation device in place of a modifiable advertisement segment in connection with an upcoming content-replacement opportunity on the content-modification-enabled channel to which the second content-presentation device is tuned.

### CROSS-REFERENCE TO RELATED APPLICATIONS

This disclosure claims priority to U.S. Provisional Pat. App. No. 63/148,220 filed Feb. 11, 2021, which is hereby incorporated by reference herein in its entirety.

### USAGE AND TERMINOLOGY

In this disclosure, unless otherwise specified and/or unless the particular context clearly dictates otherwise, the terms “a” or “an” mean at least one, and the term “the” means the at least one.

In this disclosure, the term “computing system” means a system that includes at least one computing device. In some instances, a computing system can include one or more other computing systems.

### SUMMARY

In one aspect, a method includes identifying a group of content-presentation devices that are associated with the same household. The method also includes determining that a first content-presentation device of the identified group has received a first advertisement segment. The method also includes identifying a second content-presentation device of the identified group, different from the first content-presentation device, that is tuned to a content-modification-enabled channel that supports performance of content-modification operations. The method also includes causing a replacement advertisement segment associated with the first advertisement segment to be transmitted to the second content-presentation device for output by the second content-presentation device in place of a modifiable advertisement segment in connection with an upcoming content-replacement opportunity on the content-modification-enabled channel to which the second content-presentation device is tuned.

In another aspect, a non-transitory computer-readable storage medium has stored thereon program instructions that, upon execution by a processor, cause performance of a set of operations. The set of operations includes identifying a group of content-presentation devices that are associated with the same household. The set of operations also includes determining that a first content-presentation device of the identified group has received a first advertisement segment. The set of operations also includes identifying a second content-presentation device of the identified group, different from the first content-presentation device, that is tuned to a content-modification-enabled channel that supports performance of content-modification operations. The set of operations also includes causing a replacement advertisement segment associated with the first advertisement segment to be transmitted to the second content-presentation device for output by the second content-presentation device in place of a modifiable advertisement segment in connection with an upcoming content-replacement opportunity on the content-modification-enabled channel to which the second content-presentation device is tuned.

In another aspect, a computing system includes a processor and a non-transitory computer-readable storage medium, having stored thereon program instructions that, upon execution by the processor, cause performance of a set of operations. The set of operations includes identifying a group of content-presentation devices that are associated with the same household. The set of operations also includes determining that a first content-presentation device of the identified group has received a first advertisement segment. The set of operations also includes identifying a second content-presentation device of the identified group, different from the first content-presentation device, that is tuned to a content-modification-enabled channel that supports performance of content-modification operations. The set of operations also includes causing a replacement advertisement segment associated with the first advertisement segment to be transmitted to the second content-presentation device for output by the second content-presentation device in place of a modifiable advertisement segment in connection with an upcoming content-replacement opportunity on the content-modification-enabled channel to which the second content-presentation device is tuned.

### BRIEF DESCRIPTION OF THE DRAWINGS

FIG. 1 is a simplified block diagram of an example content-modification system in which various described principles can be implemented.

FIG. 2 is a simplified block diagram of an example computing system in which various described principles can be implemented.

FIG. 3 is a diagram of example linear sequences of content and related concepts.

FIGS. 4A, 4B, 4C, 4D, 4E, and 4F collectively make up a table showing example time-periods and corresponding operations that can be performed in connection with the example content-modification system.

FIG. 5 is a flow chart of an example method.

### DETAILED DESCRIPTION

### I. Overview

To deliver and present content to end-users, a content provider can transmit the content to one or more content-distribution systems, each of which can in turn transmit the content to one or more respective content-presentation devices to be output for presentation to respective end-users. Such a hierarchical arrangement can facilitate convenient, widespread distribution of content.

By way of example, in order for a video content provider to deliver video content to end-users throughout the United States, the video content provider can transmit the video content by satellite or another medium to content-distribution systems that serve respective designated market areas (DMAs) within the United States. Each such content-distribution system can therefore receive the national satellite feed carrying the video content and can transmit the video content to television sets and/or set-top boxes in the content-distribution system's DMA, such that the video content can be output for presentation to respective end-users in that DMA. In practice, these content-distribution systems and their means of transmission to content-presentation devices can take various forms. For instance, a content-distribution system can be associated with a cable-television provider and can transmit video content to content-presentation devices of end-users who are cable-television subscribers through hybrid fiber/coaxial cable connections.

As such, in various scenarios, a content-distribution system can transmit content to a content-presentation device, which can receive and output the content for presentation to an end-user. In some situations, even though the content-presentation device receives content from the content-distribution system, it can be desirable for the content-presentation device to perform a content-modification operation so that the content-presentation device can output for presentation alternative content instead of at least a portion of that received content.

For example, in the case where the content-presentation device receives a linear sequence of content segments that includes a given advertisement segment positioned somewhere within the sequence, it can be desirable for the content-presentation device to replace the given advertisement segment with a different advertisement segment that is perhaps more targeted to the end-user (e.g., more targeted to the end-user's interests, demographics, etc.). This type of advertisement replacement may also be referred to herein as “dynamic ad insertion (DAI).” As another example, it can be desirable for the content-presentation device to overlay on the given advertisement segment, overlay content that enhances the given advertisement segment in a way that is again perhaps more targeted to the end-user. The described content-modification system can facilitate providing these and other related features.

In one example, the content-modification system can include a fingerprint-matching server that can identify an upcoming content-modification opportunity on an identified channel. The fingerprint-matching server can identify the upcoming content-modification opportunity by comparing and detecting a match between two different instances of fingerprint data. Based on the detected match, the fingerprint-matching server can then transmit fingerprint data and metadata to the content-presentation device data to facilitate preparing the content-presentation device to perform a content-modification operation in connection with the identified upcoming content-modification opportunity.

However, in other cases, it may be desirable for the content-presentation device to use one or more alternative techniques to facilitate performing a content-modification operation.

For example, the fingerprint-matching server can use broadcast-schedule data to facilitate the content-presentation device performing a content-modification operation. Among other things, this can allow the content-presentation device to facilitate performing a content-modification operation without using fingerprint data or by using fingerprint data in a more limited fashion. This can be beneficial in the case where the content-presentation device does not receive or otherwise have access to fingerprint data, or where the use of fingerprint data is undesirable for one or more reasons (e.g., because fingerprint-based techniques may be computationally expensive).

An advertiser may desire to advertise to multiple different end-users of a household. The term “household” as used herein can refer to a media-consumption entity with which one or more content-presentation devices can be associated, such as a residential building or other unit of housing, a non-residential building, or another type of geographic area (e.g., a park or sports stadium) at which such content-presentation devices are physically located or otherwise associated. In some situations, the advertiser may particularly desire to advertise goods, services, events, etc. that are specifically targeted to families or other types of end-user groups that typically occupy the same household. For instance, cars or other expensive products are often advertised to families. The advertiser may also desire to have its advertisements presented to each end-user of the household at approximately the same time so that the advertised content is fresh in the mind of each end-user. Typically, this can be achieved with standard linear advertising in situations where all members of the household are viewing the same content-presentation device and/or where all members of the household are viewing the same channel at the same time, but on two or more separate content-presentation devices. However, it can be difficult to achieve this in situations where different members of the household watch different channels on different content-presentation devices, or watch different channels on the same content-presentation device, but at different times.

Accordingly, disclosed herein are methods and systems for an improved content-modification system that facilitates advertisement exposure to multiple different content-presentation devices of the same household, and thus likely multiple different end-users of that household.

The term “household” as used herein can refer to a media-consumption entity with which one or more content-presentation devices can be associated, such as a residential building or other unit of housing, a non-residential building, or another type of geographic area (e.g., a park or sports stadium) at which such content-presentation devices are physically located or otherwise associated

In an example method, the content-modification system can identify a group of content-presentation devices that are associated with the same household. The content-modification system can then determine that a first content-presentation device of the identified group has received a first advertisement segment (e.g., a first advertisement for Product X). The content-modification system can then identify a second content-presentation device of the identified group, different from the first content-presentation device, that is tuned to a content-modification-enabled channel that supports performance of content-modification operations (e.g., a DAI-enabled channel). The content-modification system can then select a replacement advertisement segment that is associated with the first advertisement segment (e.g., a second, different advertisement for Product X, or the first advertisement for Product X) and cause the selected replacement advertisement segment to be transmitted to the second content-presentation device. The second content-presentation device can then output the replacement advertisement segment in place of a modifiable advertisement segment in connection with an upcoming content-replacement opportunity on the content-modification-enabled channel to which the second content-presentation device is tuned. For instance, in order to have the second content-presentation device display the replacement advertisement segment as soon as possible from the time the first content-presentation device received the first advertisement segment, the content-modification system can instruct the second content-presentation device to perform the replacement at the next possible content-modification opportunity that is identified on the content-modification-enabled channel. Additionally or alternatively, the content-modification system can instruct the second content-presentation device to perform the replacement at another content-modification opportunity within the same daypart (e.g., later that evening) as when the first content-presentation device displayed the first advertisement.

Other operations for facilitating advertisement exposure to multiple different content-presentation devices of the same household are described herein as well.

Furthermore, other example timing for having the second content-presentation device perform the replacement is possible as well. The disclosed methods and systems can help expose at least two content-presentation devices of the same household to the same or similar advertisements within a variety of time-windows of one another, such as within a minute, half hour, hour, or multiple hours of each other, or within the same daypart (e.g., morning, afternoon, or evening) of each other. In some instances, disclosed methods and systems can help expose the at least two content-presentation devices to the same or similar advertisements simultaneously or near-simultaneously.

### II. Architecture

A. Content-Modification System

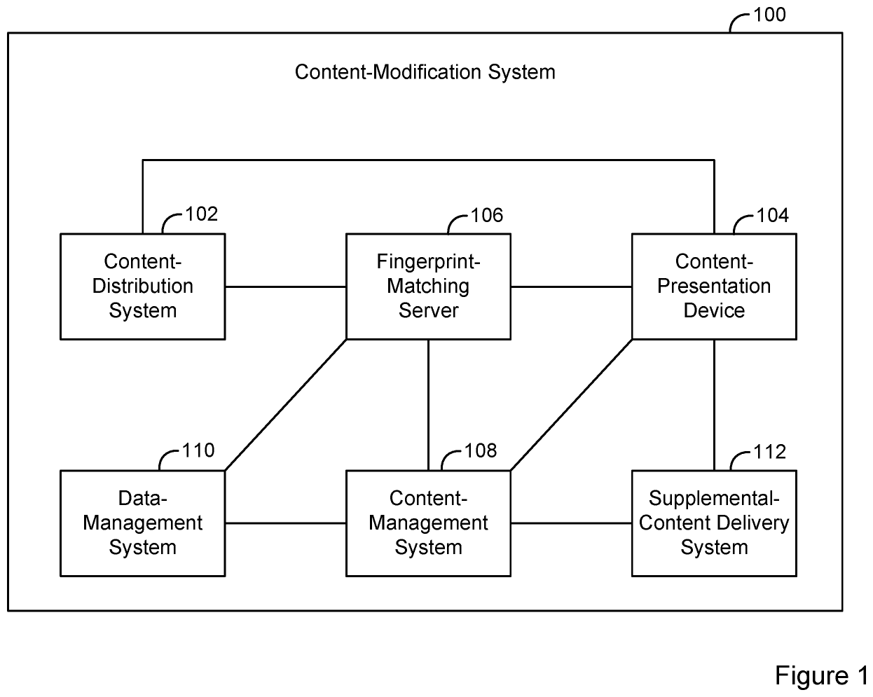

FIG. 1 is a simplified block diagram of an example content-modification system 100. The content-modification system 100 can include various components, such as a content-distribution system 102, a content-presentation device 104, a fingerprint-matching server 106, a content-management system 108, a data-management system 110, and/or a supplemental-content delivery system 112.

The content-modification system 100 can also include one or more connection mechanisms that connect various components within the content-modification system 100. For example, the content-modification system 100 can include the connection mechanisms represented by lines connecting components of the content-modification system 100, as shown in FIG. 1.

In this disclosure, the term “connection mechanism” means a mechanism that connects and facilitates communication between two or more components, devices, systems, or other entities. A connection mechanism can be or include a relatively simple mechanism, such as a cable or system bus, and/or a relatively complex mechanism, such as a packet-based communication network (e.g., the Internet). In some instances, a connection mechanism can be or include a non-tangible medium, such as in the case where the connection is at least partially wireless. In this disclosure, a connection can be a direct connection or an indirect connection, the latter being a connection that passes through and/or traverses one or more entities, such as a router, switcher, or other network device. Likewise, in this disclosure, communication (e.g., a transmission or receipt of data) can be a direct or indirect communication.

The content-modification system 100 and/or components thereof can take the form of a computing system, an example of which is described below.

Notably, in practice, the content-modification system 100 is likely to include many instances of at least some of the described components. For example, the content-modification system 100 is likely to include many content-distribution systems and many content-presentation devices.

B. Computing System

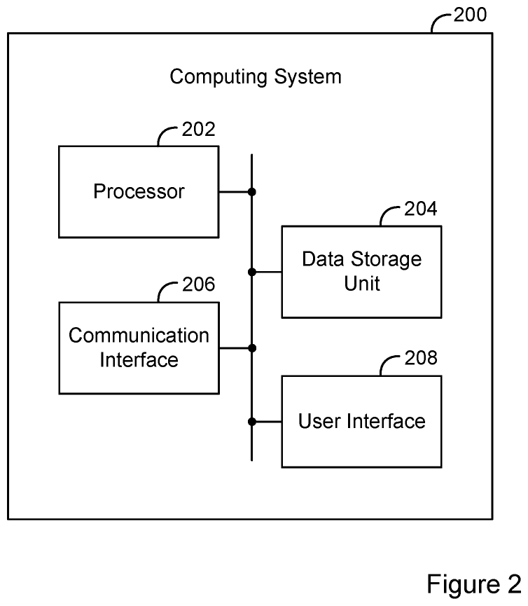

FIG. 2 is a simplified block diagram of an example computing system 200. The computing system 200 can be configured to perform and/or can perform one or more operations, such as the operations described in this disclosure. The computing system 200 can include various components, such as a processor 202, a data-storage unit 204, a communication interface 206, and/or a user interface 208.

The processor 202 can be or include a general-purpose processor (e.g., a microprocessor) and/or a special-purpose processor (e.g., a digital signal processor). The processor 202 can execute program instructions included in the data-storage unit 204 as described below.

The data-storage unit 204 can be or include one or more volatile, non-volatile, removable, and/or non-removable storage components, such as magnetic, optical, and/or flash storage, and/or can be integrated in whole or in part with the processor 202. Further, the data-storage unit 204 can be or include a non-transitory computer-readable storage medium, having stored thereon program instructions (e.g., compiled or non-compiled program logic and/or machine code) that, upon execution by the processor 202, cause the computing system 200 and/or another computing system to perform one or more operations, such as the operations described in this disclosure. These program instructions can define, and/or be part of, a discrete software application.

In some instances, the computing system 200 can execute program instructions in response to receiving an input, such as an input received via the communication interface 206 and/or the user interface 208. The data-storage unit 204 can also store other data, such as any of the data described in this disclosure.

The communication interface 206 can allow the computing system 200 to connect with and/or communicate with another entity according to one or more protocols. Therefore, the computing system 200 can transmit data to, and/or receive data from, one or more other entities according to one or more protocols. In one example, the communication interface 206 can be or include a wired interface, such as an Ethernet interface or a High-Definition Multimedia Interface (HDMI). In another example, the communication interface 206 can be or include a wireless interface, such as a cellular or WI-FI interface.

The user interface 208 can allow for interaction between the computing system 200 and a user of the computing system 200. As such, the user interface 208 can be or include an input component such as a keyboard, a mouse, a remote controller, a microphone, and/or a touch-sensitive panel. The user interface 208 can also be or include an output component such as a display device (which, for example, can be combined with a touch-sensitive panel) and/or a sound speaker.

The computing system 200 can also include one or more connection mechanisms that connect various components within the computing system 200. For example, the computing system 200 can include the connection mechanisms represented by lines that connect components of the computing system 200, as shown in FIG. 2.

The computing system 200 can include one or more of the above-described components and can be configured or arranged in various ways. For example, the computing system 200 can be configured as a server and/or a client (or perhaps a cluster of servers and/or a cluster of clients) operating in one or more server-client type arrangements, for instance.

As noted above, the content-modification system 100 and/or components thereof can take the form of a computing system, such as the computing system 200. In some cases, some or all these entities can take the form of a more specific type of computing system. For instance, in the case of the content-presentation device 104, it can take the form of a desktop computer, a laptop, a tablet, a mobile phone, a television set, a set-top box, a television set with an integrated set-top box, a media dongle, or a television set with a media dongle connected to it, among other possibilities.

### III. Example Operations

The content-modification system 100 and/or components thereof can be configured to perform and/or can perform one or more operations. Examples of these operations and related features will now be described.

As noted above, in practice, the content-modification system 100 is likely to include many instances of at least some of the described components. Likewise, in practice, it is likely that at least some of described operations will be performed many times (perhaps on a routine basis and/or in connection with additional instances of the described components).

A. Operations Related to the Content-Distribution System Transmitting Content and the Content-Presenting Device Receiving and Outputting Content

For context, general operations and examples related to the content-distribution system 102 transmitting content and the content-presentation device 104 receiving and outputting content will now be described.

To begin, the content-distribution system 102 can transmit content (e.g., that it received from a content provider) to one or more entities such as the content-presentation device 104. Content can be or include audio content and/or video content, for example. In some examples, content can take the form of a linear sequence of content segments (e.g., program segments and advertisement segments) or a portion thereof. In the case of video content, a portion of the video content may be one or more frames, for example.

The content-distribution system 102 can transmit content on one or more channels (sometimes referred to as stations or feeds). As such, the content-distribution system 102 can be associated with a single channel content distributor or a multi-channel content distributor such as a multi-channel video program distributor (MVPD).

The content-distribution system 102 and its means of transmission of content on the channel to the content-presentation device 104 can take various forms. By way of example, the content-distribution system 102 can be or include a cable-television head-end that is associated with a cable-television provider and that transmits the content on the channel to the content-presentation device 104 through hybrid fiber/coaxial cable connections. As another example, the content-distribution system 102 can be or include a satellite-television head-end that is associated with a satellite-television provider and that transmits the content on the channel to the content-presentation device 104 through a satellite transmission. As yet another example, the content-distribution system 102 can be or include a television-broadcast station that is associated with a television-broadcast provider and that transmits the content on the channel through a terrestrial over-the-air interface to the content-presentation device 104. In these and other examples, the content-distribution system 102 can transmit the content in the form of an analog or digital broadcast stream representing the content.

The content-presentation device 104 can receive content from one or more entities, such as the content-distribution system 102. In one example, the content-presentation device 104 can select (e.g., by tuning to) a channel from among multiple available channels, perhaps based on input received via a user interface, such that the content-presentation device 104 can receive content on the selected channel.

In some examples, the content-distribution system 102 can transmit content to the content-presentation device 104, which the content-presentation device 104 can receive, and therefore the transmitted content and the received content can be the same. However, in other examples, they can be different, such as where the content-distribution system 102 transmits content to the content-presentation device 104, but the content-presentation device 104 does not receive the content and instead receives different content from a different content-distribution system.

The content-presentation device 104 can also output content for presentation. As noted above, the content-presentation device 104 can take various forms. In one example, in the case where the content-presentation device 104 is a television set (perhaps with an integrated set-top box and/or media dongle), outputting the content for presentation can involve the television set outputting the content via a user interface (e.g., a display device and/or a sound speaker), such that it can be presented to an end-user. As another example, in the case where the content-presentation device 104 is a set-top box or a media dongle, outputting the content for presentation can involve the set-top box or the media dongle outputting the content via a communication interface (e.g., an HDMI interface), such that it can be received by a television set and in turn output by the television set for presentation to an end-user.

As such, in various scenarios, the content-distribution system 102 can transmit content to the content-presentation device 104, which can receive and output the content for presentation to an end-user. In some situations, even though the content-presentation device 104 receives content from the content-distribution system 102, it can be desirable for the content-presentation device 104 to perform a content-modification operation so that the content-presentation device 104 can output for presentation alternative content instead of at least a portion of that received content.

For example, in the case where the content-presentation device 104 receives a linear sequence of content segments that includes a given advertisement segment positioned somewhere within the sequence, it can be desirable for the content-presentation device 104 to replace the given advertisement segment with a different advertisement segment that is perhaps more targeted to the end-user (i.e., more targeted to the end-user's interests, demographics, etc.). As another example, it can be desirable for the content-presentation device 104 to overlay on the given advertisement segment, overlay content that enhances the given advertisement segment in a way that is again perhaps more targeted to the end-user. The described content-modification system 100 can facilitate providing these and other related features.

As noted above, in one example, content can take the form of a linear sequence of content segments. As such, in one example, the content-distribution system 102 can transmit a linear sequence of content segments. This is referred to herein as a “transmission sequence.” Likewise, the content-presentation device 104 can receive a linear sequence of content segments. This is referred to herein as a “receipt sequence.” In line with the discussion above, the transmission sequence and the receipt sequence can be the same or they can be different.

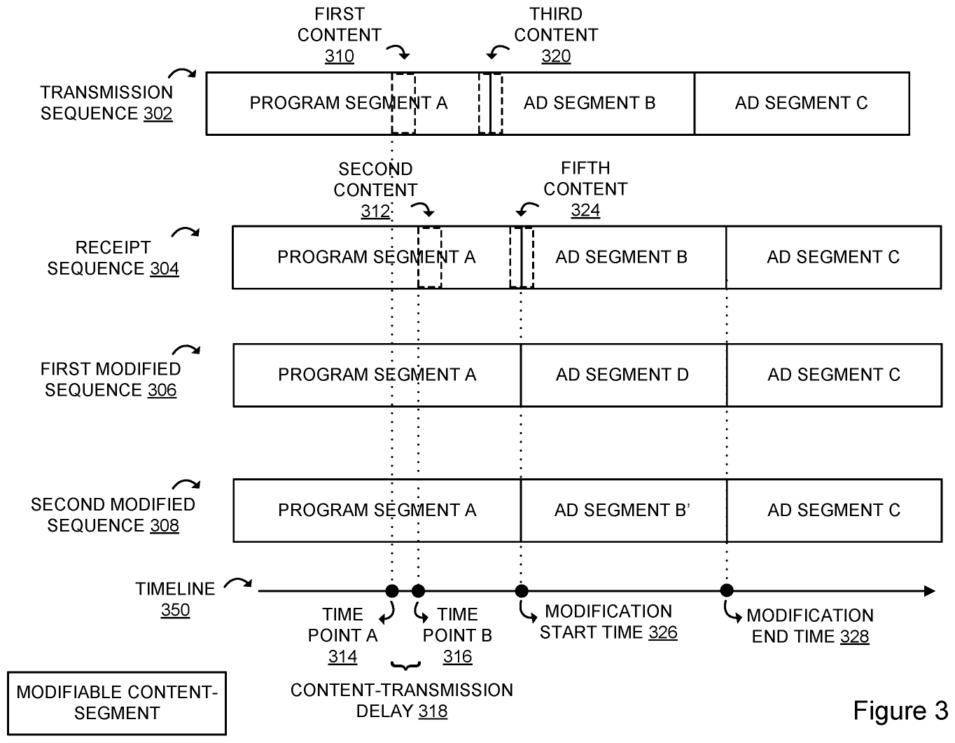

FIG. 3 illustrates some examples of these concepts. In one example, the transmission sequence is the TRANSMISSION SEQUENCE 302 shown in FIG. 3. As shown, the TRANSMISSION SEQUENCE 302 includes a PROGRAM SEGMENT A, followed by an AD SEGMENT B, followed by an AD SEGMENT C.

Likewise, in one example, the receipt sequence is the RECEIPT SEQUENCE 304 shown in FIG. 3. In this example, the content-distribution system 102 transmits the TRANSMISSION SEQUENCE 302 to the content-presentation device 104, which the content-presentation device 104 receives as the RECEIPT SEQUENCE 304, and therefore the TRANSMISSION SEQUENCE 302 and the RECEIPT SEQUENCE 304 are the same. As such, as shown, the RECEIPT SEQUENCE 304 also includes the PROGRAM SEGMENT A, followed by the AD SEGMENT B, followed by the AD SEGMENT C.

In FIG. 3, the transmission time of the TRANSMISSION SEQUENCE 302 and the receipt time of the RECEIPT SEQUENCE 304 are shown by way of their relationship to a TIMELINE 350. Notably, the transmission time and the receipt time are offset from each other due to a content-transmission delay, which is described in greater detail below.

As noted above, in some situations, even though the content-presentation device 104 receives content from the content-distribution system 102, it can be desirable for the content-presentation device 104 to perform a content-modification operation so that the content-presentation device 104 can output for presentation alternative content instead of at least a portion of that received content. For example, in the case where the content-presentation device 104 receives the receipt sequence, rather than outputting for presentation the receipt sequence, the content-presentation device 104 can output for presentation a modified version of the receipt sequence instead. This is referred to herein as a “modified sequence.”

For example, in the case where the receipt sequence includes a given advertisement segment positioned somewhere within the receipt sequence, it can be desirable for the content-presentation device 104 to replace the given advertisement segment with a different advertisement segment that is perhaps more targeted to the end-user (i.e., more targeted to the end-user's interests, demographics, etc.), thereby resulting in a modified sequence that the content-presentation device 104 can output for presentation.

To illustrate this, in one example, the modified sequence is the FIRST MODIFIED SEQUENCE 306 shown in FIG. 3. As shown, the FIRST MODIFIED SEQUENCE 306 includes the PROGRAM SEGMENT A, followed by the AD SEGMENT D (which replaced the AD SEGMENT B), followed by the AD SEGMENT C.

As another example, it can be desirable for the content-presentation device 104 to overlay on the given advertisement segment, overlay content that enhances the given advertisement segment in a way that is again perhaps more targeted to the end-user, thereby resulting in a modified sequence that the content-presentation device 104 can output for presentation.

To illustrate this, in another example, the modified sequence is the SECOND MODIFIED SEQUENCE 308 shown in FIG. 3. As shown, the SECOND MODIFIED SEQUENCE 308 includes the PROGRAM SEGMENT A, followed by the AD SEGMENT B′ (which is the AD SEGMENT B modified with overlay content), followed by the AD SEGMENT C.

Other portions of FIG. 3 will be described later in this disclosure as related concepts are introduced and described.

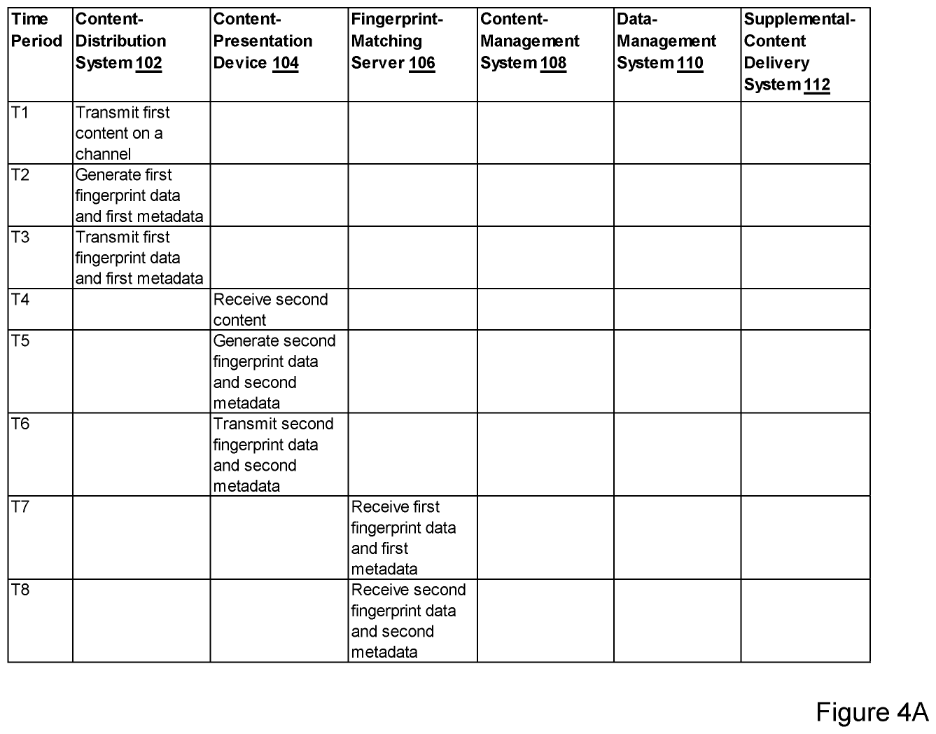

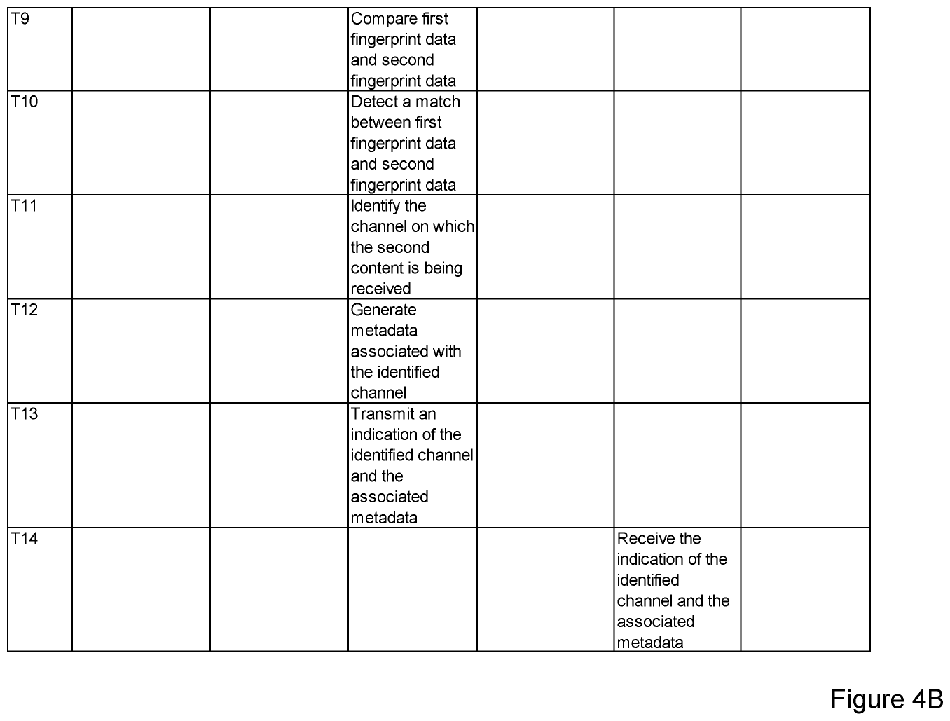

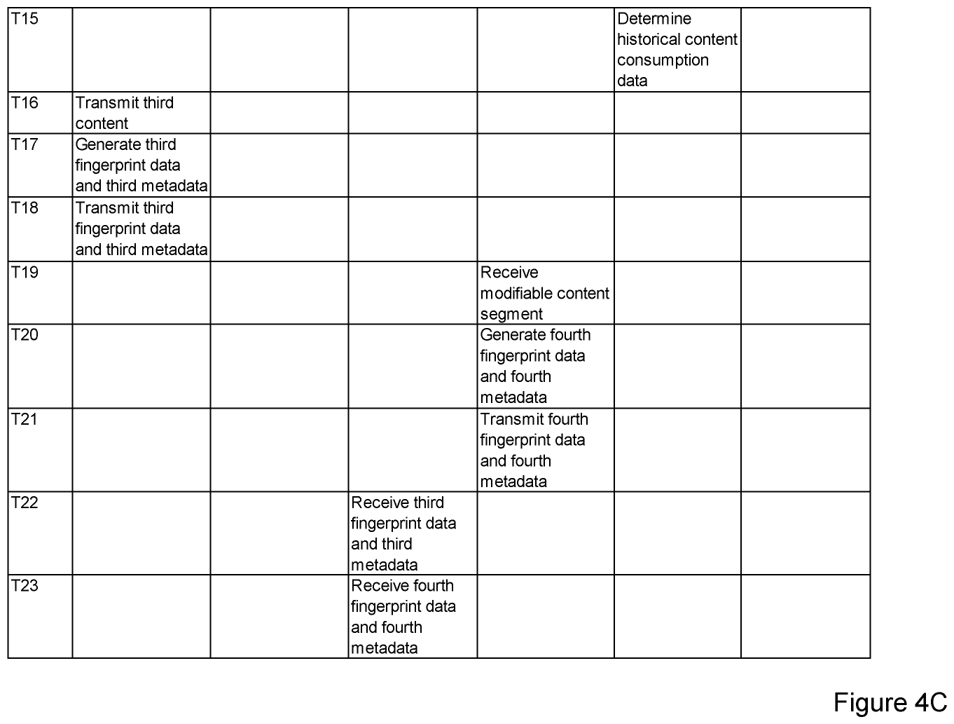

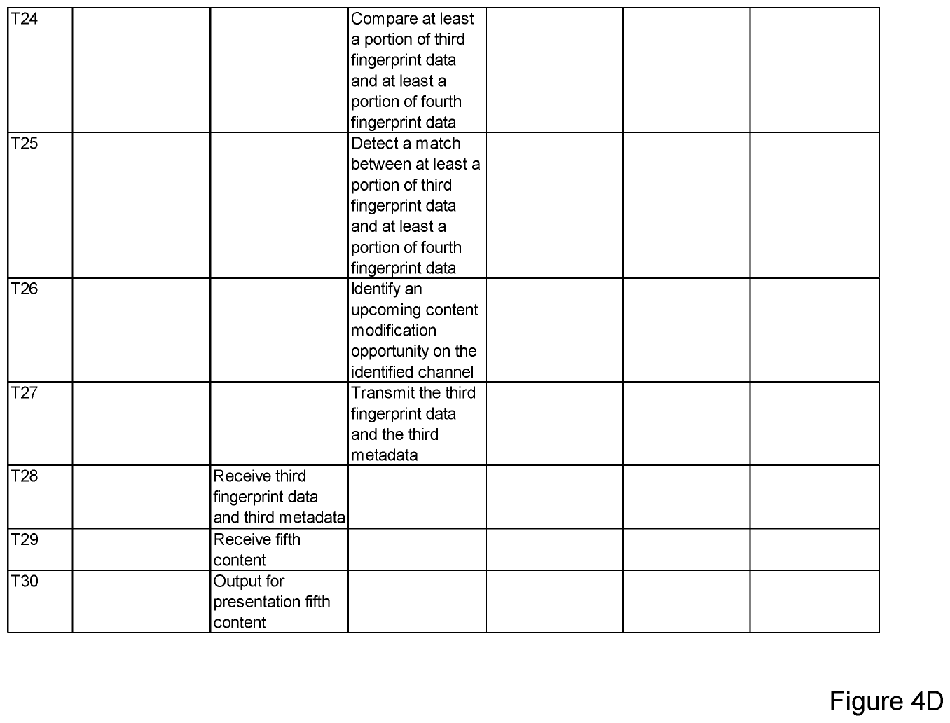

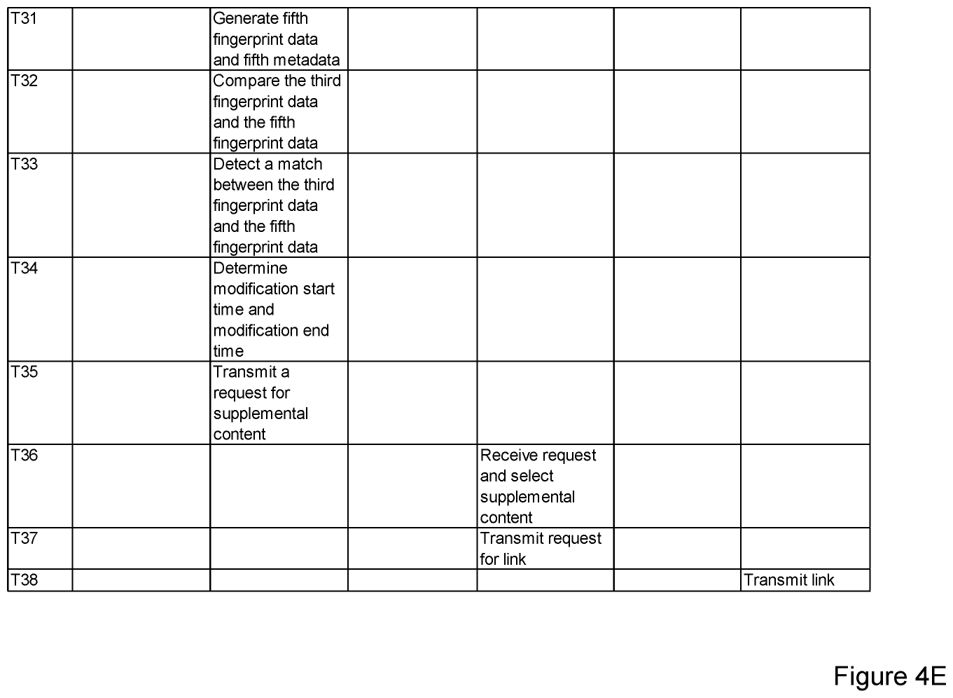

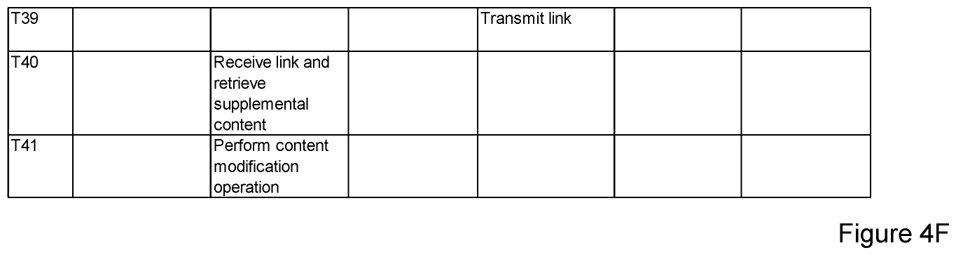

Moving on in view of the context provided above, FIGS. 4A, 4B, 4C, 4D, 4E, and 4F, collectively make up a table showing example time-periods and corresponding operations that can be performed in connection with the content-modification system 100. These and other related operations will now be described.

B. Operations Related to the Content-Distribution System Transmitting First Content on a Channel

During a time-period T1, the content-distribution system 102 can transmit content on a channel to the content-presentation device 104. This content is referred to herein as “first content.” In one example, the first content is the FIRST CONTENT 310 shown in FIG. 3.

During a time-period T2, the content-distribution system 102 can generate fingerprint data representing the first content. This fingerprint data is referred to herein as “first fingerprint data.” The content-distribution system 102 can generate the first fingerprint data using any content fingerprinting process now known or later developed. By way of example, the content-distribution system 102 can generate the first fingerprint data by selecting multiple patches of a frame of video content and calculating a value for each of the selected multiple patches. In some instances, the values can include Haar-like features at different scales and in different locations of displayed regions of the frame of video content. Further, in some instances, the values can be derived from an integral image, which is a summed image where each pixel is a sum of values of the pixels above and to the left, as well as the current pixel. Using an integral image technique may increase the efficiency of the fingerprint data generation.

The content-distribution system 102 can generate first fingerprint data at a given rate, such as at the rate of one fingerprint per frame of the first content. The first fingerprint data can be or include some or all of these generated fingerprints.

The content-distribution system 102 can access the first content at various points within the content-distribution system 102. As one example, the content-distribution system 102 can access the first content after it is output by a distribution amplifier within the content-distribution system 102.

Also during the time-period T2, the content-distribution system 102 can generate metadata associated with the first content and/or the first fingerprint data. This metadata is referred to herein as “first metadata.” In one example, the first metadata can be or include a transmission time-stamp, which represents a time-point at which the content-distribution system 102 transmitted the first content. The content-distribution system 102 can determine the transmission time-stamp in various ways, such as based on a time clock that is synchronized to a reference clock.

As another example, the first metadata can be or include a channel identifier, which identifies the channel on which the content-distribution system 102 is transmitting the first content. The content-distribution system 102 can determine the channel identifier in various ways such as based on mapping data that maps the content-distribution system 102 and/or physical inputs and/or outputs within the content-distribution system 102 to respective channel identifiers. In one example, in the case where the content-distribution system 102 transmits content A on channel A, content B on channel B, and content C on channel C, the mapping data can specify which of three different outputs (perhaps on three different distribution amplifiers) maps to which channel identifier, such that the content-distribution system 102 can determine the appropriate channel identifier for content of a given channel.

As another example, the first metadata can be or include SCTE-104 data, a watermark, or a similar type of metadata, any of which can themselves encode other metadata, such as a program identifier, an advertisement identifier (e.g., an industry standard coding identification (ISCI) key), a program genre, or another type of textual or numeric metadata, for instance.

The content-distribution system 102 can associate the first fingerprint data with the first metadata in various ways. For instance, in the case where the first fingerprint data includes multiple fingerprints with each fingerprint representing a corresponding frame of the first content, the content-distribution system 102 can associate each fingerprint with a corresponding transmission time-stamp and/or with other corresponding first metadata.

During a time-period T3, the content-distribution system 102 can transmit the first fingerprint data and the first metadata to the fingerprint-matching server 106. The content-distribution system 102 can transmit the first fingerprint data and the first metadata at a given interval. For example, every two seconds, the content-distribution system 102 can transmit the first fingerprint data and the first metadata that it generated during that most recent two-second time-period.

C. Operations Related to the Content-Presentation Device Receiving Second Content

During a time-period T4, the content-presentation device 104 can receive content from the content-distribution system 102. This content is referred to herein as “second content.” In one example, the second content is the SECOND CONTENT 312 shown in FIG. 3.

During a time-period T5, the content-presentation device 104 can generate fingerprint data representing the second content. This fingerprint data is referred to herein as “second fingerprint data.” The content-presentation device 104 can generate the second fingerprint data using any content fingerprinting process now known or later developed. The content-presentation device 104 can generate the second fingerprint data at various rates, such as at the rate of one fingerprint per frame of the second content. The second fingerprint data can be or include some or all of these generated fingerprints.

The content-presentation device 104 can access the second content at various points within the content-presentation device 104. As one example, the content-presentation device 104 can access the second content as it is being received by an input buffer (e.g., an HDMI buffer) of the content-presentation device 104. In another configuration, the content-presentation device 104 can access the second content as it is being received by a display buffer of the content-presentation device 104. In this configuration, the second content can therefore be content that the content-presentation device 104 not only receives, but also outputs for presentation.

Also during the time-period T5, the content-presentation device 104 can generate metadata associated with the second content and/or the second fingerprint data. This metadata is referred to herein as “second metadata.” As one example, the second metadata can be or include a receipt time-stamp, which represents a time-point at which the content-presentation device 104 received the second content. The content-presentation device 104 can determine the receipt time-stamp in various ways, such as based on a time clock that is synchronized to a reference clock. As noted above, the content-presentation device 104 can access the second content at various points within the content-presentation device 104. In one example, the point at which the second content is accessed can be considered the “receipt” point for purposes of determining the receipt time-stamp.

In practice, while the first metadata is likely to be or include a channel identifier, the second metadata is likely to not be nor include a channel identifier.

The content-presentation device 104 can associate the second fingerprint data with the second metadata in various ways. For instance, where the second fingerprint data includes multiple fingerprints with each fingerprint representing a corresponding frame of second content, the content-presentation device 104 can associate each second fingerprint with a corresponding receipt time-stamp and/or other corresponding metadata.

During a time-period T6, the content-presentation device 104 can transmit the second fingerprint data and the second metadata to the fingerprint-matching server 106. The content-presentation device 104 can transmit the second fingerprint data and the second metadata at a given interval. For example, every two seconds, the content-presentation device 104 can transmit the second fingerprint data and the second metadata that it generated during that most recent two-second time-period.

D. Operations Related to Identifying a Channel on Which the Content-Presentation Device is Receiving the Second Content

During a time-period T7, the fingerprint-matching server 106 can receive the first fingerprint data and the first metadata from the content-distribution system 102. As noted above, the first fingerprint data represents the first content transmitted by the content-distribution system 102 on the channel. As noted above, the first metadata can, and for the purposes of this described example does, identify the channel. In this way, the first content can be considered as content being transmitted on an identified channel.

During a time-period T8, the fingerprint-matching server 106 can receive the second fingerprint data and the second metadata from the content-presentation device 104. As noted above, the second fingerprint data represents the second content received by the content-presentation device 104. However, as noted above, the associated metadata may not, and for the purposes of this described example does not, identify the channel. In this way, the second content can be considered as content being received on an unidentified channel.

During a time-period T9, the fingerprint-matching server 106 can compare the first fingerprint data and the second fingerprint data to determine whether there is a match. In this disclosure, this type of match attempt, namely a match attempt between (i) reference fingerprint data representing content being transmitted on an identified channel and (ii) query fingerprint data representing content being received on an unidentified channel, is referred to herein as a “cold match attempt.”

During a time-period T10, based on the comparing, the fingerprint-matching server 106 can detect a match between the first fingerprint data and the second fingerprint data. The fingerprint-matching server 106 can compare and/or detect a match between fingerprint data using any content fingerprint comparing and matching technique now known or later developed. By way of example, the first fingerprint data may include a first group of fingerprints, and the second fingerprint data may include a second group of fingerprints. The fingerprint-matching server 106 can determine that the first group of fingerprints match the second group of fingerprints upon determining that a similarity between each of the query fingerprints and each of the respective reference fingerprints satisfies a predetermined threshold associated with a Tanimoto distance measurement, a Manhattan distance measurement, and/or other distance measurements associated with matching images or other visual-based content.

To effectively compare the first fingerprint data and the second fingerprint data, the fingerprint-matching server 106 may need to account for a content-transmission delay. For context, in the case where the content-distribution system 102 transmits a given frame of content on a given channel at a time-point A, for various reasons, the content-presentation device 104 may not receive that frame until a time-point B that is later (e.g., ten seconds later) than the time-point A. This type of delay is referred to herein as a “content-transmission delay.”

In one example, the time-point A, the time-point B, and the content-transmission delay can be the TIME-POINT A 314, the TIME-POINT B 316, and the CONTENT-TRANSMIS SION DELAY 318, respectively, shown FIG. 3. Note that FIG. 3 is for illustration purposes and is not necessarily to scale at least with respect to time. In practice, the actual amount of content-transmission delay may be different from the amount shown.

To help the fingerprint-matching server 106 effectively compare the first fingerprint data with the second fingerprint data, the fingerprint-matching server 106 may need to account for such a content-transmission delay. In one example, the fingerprint-matching server 106 can do this by comparing the first fingerprint data that it receives at a receipt time-point with the second fingerprint data that it receives during a time-period defined by a starting time-point and an ending time-point. The starting time-point can be the receipt time-point plus an offset representing an anticipated content-transmission delay (e.g., ten seconds), minus a tolerance a time-period (e.g., two seconds). The ending time-point can be the receipt time-point plus the offset (e.g., ten seconds), plus the tolerance a time-period (e.g., two seconds). As such, in one example where the anticipated content-transmission delay is 10 seconds, the fingerprint-matching server 106 can compare first fingerprint data that it receives at a receipt time-point with second fingerprint data that it receives during a time-period between (i) the receipt time-point plus eight seconds and (ii) receipt time-point plus twelve seconds.

In some cases, the fingerprint-matching server 106 can determine a content-transmission delay, which it can use to select an appropriate offset for use in determining the starting and ending time-points, as described above. The fingerprint-matching server 106 can determine the content-transmission delay in various ways. For example, after the fingerprint-matching server 106 detects a match based on a cold match attempt, the fingerprint-matching server 106 can determine the content-transmission delay as a difference between the corresponding transmission time-stamp (of the first metadata) and the corresponding receipt time-stamp (of the second metadata), for example. Notably, the content-transmission delay can vary from channel to channel.

During a time-period T11, based on the detected match, the fingerprint-matching server 106 can identify the channel on which the second content is being received by the content-presentation device 104. In one example, the fingerprint-matching server 106 can identify the channel based on the channel identifier metadata associated with the first fingerprint data used to detect the match.

Notably, in practice, since there are likely to be multiple potential channels on which the content-presentation device 104 is receiving the second content, the fingerprint-matching server 106 is likely to compare the second fingerprint data with multiple instances of first fingerprint data (each representing a different respective instance of first content on a different respective channel), to determine which of those multiple instances matches the second fingerprint data.

Also, in some cases, the fingerprint-matching server 106 can detect a match between the second fingerprint data and each of multiple instances of first fingerprint data (each representing a different respective instance of first content on a different respective channel). This is referred to herein as a “multimatch scenario” and can occur for various reasons. For example, this can occur when the content-distribution system 102 is transmitting the same or similar content on more than one channel at or about the same time. In this scenario, the fingerprint-matching server 106 can perform additional operations to identity, from among the multiple channels associated with the multimatch scenario, on which specific channel the content-presentation device 104 is receiving the second content. The fingerprint-matching server 106 can do this using any channel multimatch disambiguation technique now known or later developed. By way of example, responsive to determining that a fingerprint of the second fingerprint data matches multiple fingerprints of the first fingerprint data, the fingerprint-matching server 106 can (i) identify a fingerprint feature that differs as between the multiple fingerprints of the first fingerprint data and (ii) determine that a fingerprint of the second fingerprint data matches just one of the multiple fingerprints as to the identified fingerprint feature. Identifying the fingerprint feature can involve (i) referring to data that indicates a region of a frame that is channel specific to determine a region that is channel specific and (ii) identifying as the fingerprint feature a fingerprint feature corresponding with the determined region. The determined region can include a video frame edge or a region where channel identification is presented, for instance.

E. Operations Related to Determining Historical Content Consumption Data

During a time-period T12, the fingerprint-matching server 106 can generate metadata associated with the identified channel. For example, the metadata can be or include a channel identification time-stamp. The fingerprint-matching server 106 can determine the channel identification time-stamp in various ways, such as based on a time clock that is synchronized to a reference clock. In another example, the metadata can be or include a device identifier that identifies the content-presentation device 104 that is receiving content on the identified channel. The fingerprint-matching server 106 can determine the device identifier in various ways, such as by receiving it from the content-presentation device 104. In another example, the fingerprint-matching server 106 can receive data (e.g., device registration data) from the content-presentation device 104 and can use mapping data to map the received data to determine the device identifier.

During a time-period T13, the fingerprint-matching server 106 can transmit an indication of the identified channel and the associated metadata to the data-management system 110.

During a time-period T14, the data-management system 110 can receive the indication of the identified channel and the associated metadata from the fingerprint-matching server 106.

The data-management system 110 can use the received indication of the identified channel and the associated metadata, perhaps with other data, to determine when the content-presentation device 104 has received content on the identified channel, what specific content the content-presentation device 104 has received, etc. This type of data is referred to herein as “historical content consumption data.”

As such, during a time-period T15, the data-management system 110 can determine historical content consumption data associated with the content-presentation device 104.

F. Operations Related to the Content-Distribution System Transmitting Third Content

As noted above, the fingerprint-matching server 106 can identify the channel on which the content-presentation device 104 is receiving the second content.

During a time-period T16, the content-distribution system 102 can transmit content on the identified channel to the content-presentation device 104. This content is referred to herein as “third content.” In one example, the third content is the THIRD CONTENT 320 shown in FIG. 3. In practice, the content-distribution system 102 is likely to transmit the third content shortly after (e.g., immediately after or a few seconds or minutes after) transmitting the first content.

During a time-period T17, the content-distribution system 102 can generate fingerprint data representing the third content. This fingerprint data is referred to herein as “third fingerprint data.”

Also during the time-period T17, the content-distribution system 102 can generate metadata associated with the third content and/or the third fingerprint data. This metadata is referred to herein as “third metadata.” The content-distribution system 102 can also associate the third fingerprint data with the third metadata.

During a time-period T18, the content-distribution system 102 can transmit the third fingerprint data and the third metadata to the fingerprint-matching server 106.

The content-distribution system 102 can transmit the third content, generate the third fingerprint data, generate the third metadata, associate the third fingerprint data with the third metadata, and transmit the third fingerprint data and the third metadata in various ways, such as ways that are the same as or similar to those described above in connection with transmitting the first content, generating the first fingerprint data, generating the first metadata, associating the first fingerprint data with the first metadata, and transmitting the first fingerprint data and the first metadata.

G. Operations Related to the Content-Management System Receiving a Modifiable Content-Segment

During a time-period T19, the content-management system 108 can receive content in the form of a content segment that has been identified as a candidate to be modified. This content is referred to herein as a “modifiable content-segment” or “fourth content.” In one example, the modifiable content-segment is the MODIFIABLE CONTENT-SEGMENT shown in FIG. 3.

The modifiable content-segment can take various forms. For example, the modifiable content-segment can be an advertisement segment (e.g., a commercial) or a program segment. As such, in one example, the modifiable content-segment can be an advertisement segment that has been identified as a candidate to be modified, perhaps by way of being replaced with a different advertisement segment, and/or by way of having content overlaid thereon.

In one example, a user, perhaps associated with the content-distribution system 102, can facilitate uploading the modifiable content-segment to the content-management system 108, such that the content-management system 108 can receive it in this way.

During a time-period T20, the content-management system 108 can generate fingerprint data representing the modifiable content-segment. This fingerprint data is referred to herein as “fourth fingerprint data.” The content-management system 108 can generate the fourth fingerprint data using any fingerprint generation technique now known or later developed. The content-management system 108 can generate the fourth fingerprint data at a given rate, such as at the rate of one fingerprint per frame of the fourth content. The fourth fingerprint data can be or include some or all of these generated fingerprints.

Also during the time-period T20, the content-management system 108 can generate metadata associated with the modifiable content-segment and/or the fourth fingerprint data. This metadata is referred to herein as “fourth metadata.” As one example, the fourth metadata can be or include a duration of the modifiable content-segment. The content-management system 108 can determine the duration in various ways, such as based on the fingerprint generation process. For example, in the case where the content-management system 108 generating the fourth fingerprint data involves generating one fingerprint per frame, where the modifiable content-segment has a frame rate of 30 frames per second, and where the fingerprinting process results in 300 fingerprints being generated, the content-management system 108 can deduce that the modifiable content-segment has a duration of ten seconds. The metadata can also be or include other information about the modifiable content-segment, such as a content segment identifier, a title, and/or specifics about permissible ways in which the modifiable content-segment can be modified, etc.

During a time-period T21, the content-management system 108 can transmit the fourth fingerprint data and the fourth metadata to the fingerprint-matching server 106.

In practice, the content-management system 108 is likely to receive many modifiable content-segments. In such situations, the content-management system 108 can perform one or more of the operations described above, as appropriate for each of the many received modifiable content-segments. As such, the content-management system 108 can transmit many instances of fourth fingerprint data, each corresponding with a different respective modifiable content-segment, to the fingerprint-matching server 106.

H. Operations Related to the Fingerprint-Matching Server Identifying an Upcoming Content Modification Opportunity on the Identified Channel

During a time-period T22, the fingerprint-matching server 106 can receive the third fingerprint data and the third metadata from the content-distribution system 102. As noted above, the third fingerprint data represents the third content transmitted by the content-distribution system 102 on the identified channel.

During a time-period T23, the fingerprint-matching server 106 can receive the fourth fingerprint data and the fourth metadata from the content-management system 108. As noted above, the fourth fingerprint data represents the modifiable content-segment.

During a time-period T24, the fingerprint-matching server 106 can compare at least a portion of the third fingerprint data with at least a portion of the fourth fingerprint data to determine whether there is a match.

During a time-period T25, based on the comparing, the fingerprint-matching server 106 can detect a match between the at least a portion of the third fingerprint data and the at least a portion of the fourth fingerprint data. The fingerprint-matching server 106 can compare and/or detect a match between fingerprint data using any content fingerprint comparing and matching process now known or later developed.

During a time-period T26, based on the detected match, the fingerprint-matching server 106 can determine that at least a portion of the modifiable content-segment is included within the third content, and therefore can identify an upcoming content-modification opportunity on the identified channel. For example, the fingerprint-matching server 106 can determine that at least a beginning portion of the MODIFIABLE CONTENT-SEGMENT is included within the THIRD CONTENT 320, as shown in FIG. 3, and therefore can identify an upcoming content-modification opportunity.

As noted above, the fingerprint-matching server 106 can receive third metadata, which can be the same as or similar to the first metadata. As such, the third metadata can be or include a transmission time-stamp and/or a channel identifier, for example. However, the third metadata can also be or include a position of at least a portion of the modifiable content-segment within the third content. In one example, the metadata can specify this using a starting frame marker and an ending frame marker, each corresponding with a respective frame of the third content. The fingerprint-matching server 106 can determine the starting frame marker and the ending frame marker based on the matching.

Notably, in practice, since there are likely to be multiple potential modifiable content-segments where portions thereof could be included within the third content, the fingerprint-matching server 106 is likely to compare at least a portion of the third fingerprint data with at least a portion of multiple instances of fourth fingerprint data (each representing a different respective instance of a modifiable content-segment), to determine which of those multiple instances of the fourth fingerprint data has a portion that matches the at least a portion of the third fingerprint data.

I. Operations Related to Preparing the Content-Presentation Device to Perform a Content-Modification Operation in Connection with the Identified Upcoming Content Modification Opportunity

During a time-period T27, based on the detected match, the fingerprint-matching server 106 can transmit the third fingerprint data and the third metadata to the content-presentation device 104 data to facilitate preparing the content-presentation device 104 to perform a content-modification operation in connection with the identified upcoming content-modification opportunity.

During a time-period T28, the content-presentation device 104 can receive the third fingerprint data and the third metadata from the fingerprint-matching server 106.

During a time-period T29, the content-presentation device 104 can receive content on the identified channel. This content is referred to herein as “fifth content.” In one example, the fifth content is the FIFTH CONTENT 324 shown in FIG. 3.

For various reasons (e.g., due to a transmission delay associated with transmitting fingerprint data and metadata being shorter that the content-transmission delay), the content-presentation device 104 can receive the third fingerprint data and the third metadata from the fingerprint-matching server 106 before receiving the fifth content from the content-distribution system 102. In this way, the content-presentation device 104 can receive fingerprint data representing content that the content-presentation device 104 is expecting to receive shortly thereafter, and that the content-presentation device should actually receive shortly thereafter unless an interruption event (e.g., a channel-change event) occurs.

In practice, similar to how the content-distribution system 102 is likely to transmit the third content shortly after (e.g., immediately after or a few seconds or minutes after) transmitting the first content, the content-presentation device 104 is likely to receive the fifth content shortly after (e.g., immediately after or a few seconds or minutes after) receiving the second content.

During a time-period T30, the content-presentation device 104 can output for presentation at least a portion of the fifth content. For example, referring to FIG. 3, the content-presentation device can output for presentation the portion of the FIFTH CONTENT 324 that is the end portion of the PROGRAM SEGMENT A.

As noted above, in some situations, even though the content-presentation device 104 receives content from the content-distribution system 102, it can be desirable for the content-presentation device 104 to perform a content-modification operation so that the content-presentation device 104 can output for presentation alternative content instead of at least a portion of the received content.

As such, even though the content-presentation device 104 receives the fifth content and outputs for presentation at least a portion of the fifth content, it can be desirable for the content-presentation device 104 to perform a content-modification operation so that the content-presentation device 104 can also output for presentation alternative content instead of at least another portion (e.g., the remaining portion) of the fifth content. For example, referring to FIG. 3, it can be desirable for the content-presentation device 104 to replace at least a portion of the AD SEGMENT B with at least a portion of a different advertisement segment that is perhaps more targeted to the end-user. As another example, it can be desirable for the content-presentation device 104 to overlay on at least a portion of the AD SEGMENT B, overlay content that enhances at least a portion of the AD SEGMENT B in a way that is again perhaps more targeted to the end-user.

During a time-period T31, the content-presentation device 104 can generate fingerprint data representing the fifth content. This fingerprint data is referred to herein as “fifth fingerprint data.” The content-presentation device 104 can generate the fifth fingerprint data using any content fingerprinting process now known or later developed. The content-presentation device 104 can generate the fifth fingerprint data at various rates, such as at the rate of one fingerprint per frame of the fifth content. The fifth fingerprint data can be or include some or all of these generated fingerprints.

Also during the time-period T31, the content-presentation device 104 can generate metadata associated with the fifth content and/or the fifth fingerprint data. This metadata is referred to herein as “fifth metadata.”

The content-presentation device 104 can receive the fifth content, generate the fifth fingerprint data, generate the fifth metadata, associate the fifth fingerprint data with the fifth metadata in various ways, such as ways that are the same as or similar to those described above in connection with receiving the second content, generating the second fingerprint data, generating the second metadata, and associating the second fingerprint data with the second metadata.

As noted above, the content-presentation device 104 can receive the third fingerprint data from the fingerprint-matching server 106 and can generate the fifth fingerprint data.

During a time-period T32, the content-presentation device 104 can compare the third fingerprint data and the fifth fingerprint data to determine whether there is a match.

During a time-period T33, based on the comparing, the content-presentation device 104 can detect a match between the third fingerprint data and the fifth fingerprint data. In this disclosure, this type of match attempt, namely a match attempt between (i) reference fingerprint data representing content transmitted by the content-distribution system 102 on an identified channel (at least based on the most recent channel identification analysis), and (ii) query fingerprint data representing content being received by the content-presentation device 104 on the same identified channel, is referred to herein as a “hot match attempt.” The content-presentation device 104 can compare and/or detect a match between fingerprint data using any content fingerprint comparing and matching process now known or later developed.

During a time-period T34, based on the detected match, the content-presentation device 104 can determine a time-point at which the identified upcoming modification opportunity starts. This is referred to herein as the “modification start-time.” In one example, the modification start-time is the MODIFICATION START-TIME 326 as shown FIG. 3.

In one example, the content-presentation device 104 can determine the modification start-time by starting with the transmission time-stamp associated with the starting frame marker (which, as described above, can be or be included in the third metadata) and adding the content-transmission delay to that transmission time-stamp, to arrive at the modification start-time.

As another example, the content-presentation device 104 can determine the modification start-time by first establishing a synchronous lock between the third content, the third fingerprint data, and/or the third metadata on the one hand, and the fifth content, the fifth fingerprint data, and/or the fifth metadata, on the other hand. The content-presentation device 104 can establish the synchronous lock using any synchronous lock technique now known or later developed. By way of example, the fingerprint-matching server 106 can transmit, to the content-presentation device 104, at least a portion of the third fingerprint data, and the content-presentation device 104 can increase the frame rate at which the content-presentation device 104 generates the fifth fingerprint data. The content-presentation device 104 can then use the third and fifth fingerprint data—namely, the time-stamps at which the third and fifth fingerprint data were generated—as a basis to establish synchronous lock (e.g., a time offset) between (i) true time defined along a timeline within the content being transmitted by the content-distribution system 102 and (ii) client time defined according to a clock of the content-presentation device 104. As another example, the fingerprint-matching server 106 can establish synchronous lock as described above and then inform the content-presentation device 104.

The content-presentation device 104 can then determine the modification start-time by determining a time-period between (i) a current receipt time-stamp associated with a first portion of the fifth content that the content-presentation device 104 is currently receiving and (ii) based on the synchronous lock, an anticipated receipt time-stamp associated with a second portion of the fifth content that is the start of the modifiable content-segment, and then adding the determined time-period to the current receipt time-stamp, to arrive at the modification start-time.

Also during the time-period T34, based on the detected match, the content-presentation device 104 can determine a time-point at which the identified upcoming modification opportunity ends. This is referred to herein as the “modification end-time.” In one example, the modification end-time is the MODIFICATION END-TIME 328 as shown FIG. 3.

In one example, the content-presentation device 104 can determine the modification end-time by starting with the modification start-time and adding the duration of the modifiable content-segment (which, as described above, can be or be included in the fourth metadata) to the modification start-time, to arrive at the modification end-time.

Notably, if the content-presentation device 104 performs a hot match attempt and does not detect a match, the content-presentation device 104 can determine that the content-presentation device 104 is no longer receiving content on the most recently identified channel. In response, the content-presentation device 104 can repeat one or more of the operations described above so that the fingerprint-matching server 106 can perform another cold match attempt, to attempt to identify the channel again.

During a time-period T35, the content-presentation device 104 can transmit a request for content for use in connection with performing the content-modification operation, to the content-management system 108. This content is referred to herein as “supplemental content.” In one example, the content-presentation device 104 can transmit the request before the modification start-time (e.g., ten seconds before). In some cases, the request can include selection criteria for the supplemental content, which the content-presentation device 104 can determine based on the third metadata that the content-presentation device 104 receives from the fingerprint-matching server 106, for instance.

For example, the selection criteria can specify a requested type of content (e.g., a replacement content segment or overlay content), duration (e.g., 15 seconds, 30 seconds, or 60 seconds), aspect ratio (e.g., 4:3 or 16:9), and/or resolution (e.g., 720p or 1080p).

During a time-period T36, the content-management system 108 can receive the request and use it as a basis to select supplemental content from among multiple supplemental content items that are available for selection. In some cases, the content-management system 108 can receive and consider various data to help inform which supplemental content to select. For example, the content-management system 108 can receive historical content consumption data for the content-presentation device 104 from the data-management system 110 and/or the content-management system 108 can receive demographic data from a demographic data provider. The content-management system 108 can then use at least the received historical content consumption data and/or the received demographic data as a basis to select the supplemental content.

The content-management system 108 can cause the selected supplemental content to be transmitted to the content-presentation device 104. In one example, the content-management system 108 can do this by communicating with a supplemental-content delivery system 112 that can host the supplemental content. The supplemental-content delivery system 112 can take various forms and can include various components, such as a content distribution network (CDN).

During a time-period T37, the content-management system 108 can transmit a request for a link (e.g., a Uniform Resource Identifier (URI) or a Uniform Resource Locator (URL)) pointing to the hosted supplemental content, to the supplemental-content delivery system 112.

During a time-period T38, the supplemental-content delivery system 112 can receive and respond to the request for the link by transmitting the requested link to the content-management system 108.

During a time-period T39, the content-management system 108 can then in turn transmit the link to the content-presentation device 104.

During a time-period T40, the content-presentation device 104 can receive the link, which it can use to retrieve the supplemental content from the supplemental-content delivery system 112, such that the content-presentation device 104 can use the retrieved supplemental content in connection with performing the content-modification operation. In one example, the content-presentation device 104 can retrieve the supplemental content and store the supplemental content in a data-storage unit of the content-presentation device 104.

As such, in some examples, the content-presentation device 104 can receive the modifiable content-segment from one source (e.g., the content-distribution system 102), and the supplemental content from another source (e.g., the supplemental-content delivery system 112). These segments can be transmitted to, and received by, the content-presentation device 104 in different ways. For example, the content-distribution system 102 can transmit, and the content-presentation device 104 can receive, the modifiable content-segment as a broadcast stream transmission, whereas the supplemental-content delivery system 112 can transmit, and the content-presentation device 104 can receive, the supplemental content as an over-the-top (OTT) transmission. In this context, in one example, the content-distribution system 102 can receive the modifiable content-segment via one communication interface (e.g., an HDMI interface), and the content-presentation device 104 can receive the supplemental content via a different communication interface (e.g., an Ethernet or WI-FI interface).

J. Operations Related to the Content-Presentation Device Performing a Content-Modification Operation

At a time-period T41, the content-presentation device 104 can perform the content-modification operation. The content-presentation device 104 can do this in various ways, perhaps depending on the type of content-modification operation to be performed.

In one example, the content-presentation device 104 performing a content-modification operation can involve the content-presentation device 104 modifying the modifiable content-segment by replacing it with supplemental content. This is referred to herein as a “content-replacement operation.” For example, in this scenario, the content-presentation device 104 can receive a linear sequence of content segments that includes the modifiable content-segment and the associated metadata, and can also receive the supplemental content segment, as described above. The content-presentation device 104 can output for presentation the sequence of content segments up until the modification start-time (which corresponds to the start of the modifiable content-segment), at which time the content-presentation device 104 can switch to outputting for presentation the supplemental content instead. Then, at the modification end-time (which corresponds to the end of the modifiable content-segment), the content-presentation device 104 can switch back to outputting for presentation the content that follows in the linear sequence of content segments (or perhaps to other content, such as additional supplemental content that is replacing another modifiable content-segment).

In one example, the operation of the content-presentation device 104 switching from outputting the sequence of content segments to outputting the supplemental content can involve using various buffers of the content-presentation device 104. For example, this can involve the content-presentation device 104 switching from using first data in a first input buffer where the sequence of content segments is being received to using second data in a second input buffer where the supplemental content is being received, to populate a display buffer.

As such, according to one example as illustrated in FIG. 3, by performing a content replacement operation, the content-presentation device 104 can replace the AD SEGMENT B with the AD SEGMENT D. As a result, rather than outputting for presentation the RECEIPT SEQUENCE 304, the content-presentation device can instead output for presentation the FIRST MODIFIED SEQUENCE 306.

In another example, the content-presentation device 104 performing a content-modification operation can involve the content-presentation device 104 modifying a modifiable content-segment by overlaying on the modifiable content-segment, overlay content (referred to herein as a “content overlay operation”). For example, in this scenario, the content-presentation device 104 can again receive a linear sequence of content segments that includes the modifiable content-segment and the associated metadata, and the content-presentation device 104 can also receive the supplemental content, as described above.

The content-presentation device 104 can then output for presentation the modifiable content-segment as it ordinarily would, except that starting at the modification start-time, the content-presentation device 104 can start overlaying the supplemental content on the modifiable content-segment. The content-presentation device 104 can continue overlaying the supplemental content until the modification end-time. In this way, the content-presentation device 104 can overlay the supplemental content during at least some temporal portion of the modifiable content-segment.

In one example, the operation of the content-presentation device 104 overlaying supplemental content on the modifiable content-segment can involve using various buffers of the content-presentation device 104. For example, this can involve the content-presentation device 104 using a portion of first data in a first input buffer where the sequence of content segments is being received together with second data in a second input buffer where the supplemental content is being received, for the purposes of populating a display buffer. In this way, the content-presentation device can combine relevant portions of the modifiable content-segment (i.e., all portions except those representing region where the supplemental content is to be overlaid) together with the supplemental content to be used as an overlay, to create the desired modifiable content-segment plus the supplemental content overlaid thereon.

As such, according to one example as illustrated in FIG. 3, by performing a content overlay operation, the content-presentation device 104 can overlay supplemental content on the AD SEGMENT B, thereby modifying it to AD SEGMENT B′. As a result, rather than outputting for presentation the RECEIPT SEQUENCE 304, the content-presentation device can instead output for presentation the SECOND MODIFIED SEQUENCE 308.

In some examples, the content-presentation device 104 can perform an entirety of a content-modification operation (e.g., a replacement or overlay action, as described above) while tuned to the channel on which the RECEIPT SEQUENCE 304 is received, unless an intervening event occurs that might cause the content-modification operation (or the output of the resulting content) to be stopped, such as a channel change or a powering down of the content-presentation device 104 and/or associated display device. Thus, the FIRST MODIFIED SEQUENCE 306 or the SECOND MODIFIED SEQUENCE 308 can be output on the same channel on which the content-presentation device 104 is tuned—that is, the channel on which the modifiable content-segment is received and on which the content-modification opportunity was identified.

K. Tracking and Reporting Operation-Related Data

To help facilitate performance of various operations such as the content-presentation device 104 performing a content-modification operation and to help allow for the tracking and reporting of such operations, the content-modification system 100 and/or components thereof can track and report various operation-related data at various times and in various ways.

As just a few illustrative examples, responsive to certain operations being performed, such as those described herein, the fingerprint-matching server 106, the content-presentation device 104, and/or another entity can generate, store, and/or transmit messages that indicate (i) that a modifiable content-segment has been identified, (ii) that a channel has been identified/confirmed (perhaps based on a match detected as a result of a cold or hot match attempt), (iii) that an upcoming content-modification opportunity on the identified channel has been identified, (iv) that supplemental content has been requested, (v) that supplemental content has been received, (vi), that a content-modification operation has started, (vii) that a content-modification operation has ended, and/or (viii) that a scheduled content-modification operation was aborted and/or not performed for any given reason. In some cases, these messages can include other metadata related to these operations. For example, the metadata can specify relevant timing information, device identifiers, channel identifiers, content segment identifiers, etc.

L. Watermark-Based Techniques

Although this disclosure has described the content-modification system 100 using fingerprint-based technology to perform various operations and to provide various features, in some examples, the content-modification system 100 can use watermark-based techniques instead of, or in addition to, fingerprint-based techniques, to perform these and other operations and to provide these and other features.

For example, as an alternative to the fingerprint-based technique described above in which the fingerprint-matching server 106 identifies the channel on which the second content is being received by the content-presentation device 104, the content-distribution system 102 or another entity can insert a channel identifier in the form of a watermark into the second content, such that the fingerprint-matching server 106, the content-presentation device 104, or another entity can extract the channel identifier and use it to identify the channel on which the second content is being received by the content-presentation device 104.

In this context, the content-modification system 100 can employ any watermark technique now known or later developed.

M. Exposing Multiple Content-Presentation Devices in a Household to the Same or Similar Advertisements

In line with the discussion above, one or more computing systems of the content-modification system 100 can perform operations that improve the manner in which similar or identical advertisement segments are exposed to multiple different content-presentation devices of the same household.

In some examples, multiple content-presentation devices can display such advertisement segments simultaneously or near-simultaneously. In the context of the present disclosure, simultaneous exposure of advertisement segments to two or more content-presentation devices can involve exposure of the respective advertisement segments to the two or more content-presentation devices at substantially the same time (e.g., within a fraction of a second of each other), whereas near-simultaneous exposure can involve exposure of the respective advertisement segments to the two or more content-presentation devices within anywhere from one second of each other to a few seconds of each other.

In other examples, multiple different content-presentation devices of a household can display such advertisement segments within a predefined time-window of each other, such as one minute, five minutes, fifteen minutes, a half hour, or multiple hours.

As indicated above, the term “household” as used herein can refer to a media-consumption entity with which one or more content-presentation devices can be associated, such as a residential building or other unit of housing, a non-residential building, or another type of geographic area (e.g., a park or sports stadium) at which such content-presentation devices are physically located or otherwise associated. In some cases, multiple different end-users may be associated with the same household. In other cases a single end-user may be associated with a household at which multiple content-presentation devices are present.

Furthermore, although the following operations are described primarily in the context of advertisements, it should be understood that the operations can also apply with respect to providing other types of content segments, such as program segments (e.g., television programs), news segments, or weather segments.

As noted above, the content-management system 108 can identify a group of content-presentation devices that are associated with the same household. To facilitate this, for instance, the content-management system 108 can receive, over time, data from content-presentation devices that includes device identifiers of the content-presentation devices and/or other information that identifies the households to which the content-presentation devices belong. In some examples, this data can be or include a request for supplemental content for use in connection with an upcoming content-modification opportunity. An example request from a content-presentation device 104 can include, for instance, (i) an Internet protocol (IP) address (e.g., a public IP address of the household to which the content-presentation device 104 belongs), (ii) a device identifier of the content-presentation device 104, (iii) a hashed version of the IP address and/or the device identifier of the content-presentation device 104, (iv) a content-segment identifier for the modifiable content-segment (e.g., an ISCI key or Ad-ID), (v) a transmission time at which a content-distribution system is scheduled to start broadcasting the modifiable content-segment (which can distinguish one scheduled broadcast time of the modifiable content-segment from other possible scheduled broadcast times), (vi) a channel identifier for a channel on which the content-presentation device 104 is scheduled to receive the modifiable content-segment, and/or (vii) other information associated with a household to which the content-presentation device 104 belongs, such as a geolocation of the content-presentation device 104, demographic information, and/or historical content consumption data.

Upon receiving the data from the content-presentation deices, the content-management system 108 can store the received data in memory. The content-management system 108 can then use the received data to group the content-presentation devices by household. For example, the content-management system 108 can identify multiple content-presentation devices that are each transmitting requests for supplemental content or transmitting other communications from the same IP address and map their device identifiers to that IP address, thereby creating a group that represents a household.

The content-management system 108 can group the content-presentation devices and identify households in other ways as well, additionally or alternatively to using IP addresses. For example, demographic data can be used at times to identify households and group content-presentation devices. Demographic data or other, non-IP-related data can be useful in situations in which identical IP addresses can be misleading. In particular, an advertiser may desire to provide advertisements to a household, yet there are situations in which numerous content-presentation devices that are not part of the same household may still have the same IP address. For instance, content-presentation devices might be associated in a different way that causes the content-presentation devices to share the same IP address, such as content-presentation devices that are located in the same building or campus of buildings associated with a particular business.

In some embodiments, the content-management system 108 can be configured in some embodiments such that when a group of content-presentation devices exceeds a particular threshold quantity, the content-management system 108 can disregard that group as a household. For instance, it can be desirable in some situations to perform the disclosed operations with respect to a residential household where there are typically less content-presentation devices (e.g., six or less) as opposed to another type of “household” such as a business building where there are many more content-presentation devices (e.g., fifty or more). Thus, the content-management system 108 can optionally be configured in some embodiments such that business buildings or other media-consumption entities having numerous content-presentation devices are not considered as households for the purposes of the disclosed operations.

Having identified the group of content-presentation devices that are associated with the same household, the content-management system 108 can determine that one content-presentation device of the identified group of content-presentation devices has been exposed to a linear advertisement. That is, the content-management system 108 can determine that the content-presentation device received (and perhaps also presented, e.g., for display on a display device of that content-presentation device) an advertisement segment as part of a linear sequence of content. This content-presentation device is referred to herein as the “first content-presentation device.” Further, this advertisement segment may be alternatively referred to herein as the “first advertisement segment.”

The determination that the first content-presentation device has received the first advertisement segment can be performed using automatic content recognition (ACR) techniques (e.g., fingerprint matching, watermarking, etc.), for instance. As a more specific example, the fingerprint-matching server 106 can detect a match between query fingerprint data received from the content-presentation device and reference fingerprint data representing the first advertisement segment. Upon detecting the match, the fingerprint-matching server 106 can notify the content-management system 108 that the content-presentation device has received the first advertisement segment. Other examples are possible as well, as well as other techniques that could be used to determine that the content-presentation device has received the first advertisement segment.

In some situations, an advertiser can submit advertisement segments that the advertiser would like to have subject to the herein-described exposure techniques. That is, the first advertisement segment can be an advertisement segment that the advertiser would like to have exposed to multiple different content-presentation devices of the same household simultaneously, near-simultaneously, or within another predefined time-window. The timing of the preferred exposure could be specified in linear advertising campaign data or other data that the content-modification system 100 can store or otherwise access, for instance. As such, the act of determining that the first content-presentation device has received the first advertisement segment can involve the content-management system 108 referring to a list of advertisement segments for which advertisers have requested the herein-described exposure techniques and determining that the advertisement segment that the first content-presentation device received is on the list.

In response to determining that the first content-presentation device has received the first advertisement segment, the content-management system 108 can identify a second, different content-presentation device of the identified group that is tuned to a content-modification-enabled channel that supports performance of content-modification operations.

Herein, a “content-modification-enabled channel” refers to a channel on which content-modification operations can be performed with respect to the underlying linear sequences of content transmitted on that channel, such as a channel that supports DAI. The content-modification-enabled channel to which the second content-presentation device is tuned can be the same channel on which the first content-presentation device received the first advertisement segment, or can be a different channel.

In some examples, the act of identifying the second content-presentation device can involve accessing a stored list of content-modification-enabled channels and determining whether the channel to which the second content-presentation device is tuned is on the stored list.

In other examples, the ACR system of the second content-presentation device may be set up in such a way that information being sent from the second content-presentation device (e.g., query fingerprint data that is generated and sent) could include a flag that indicates that the channel to which the second content-presentation device is tuned is a content-modification-enabled channel. Then, when the content-management system 108 or fingerprint-matching server 106 queries the ACR system for information about which channel the second content-presentation device is tuned to, the ACR system would be able to provide the flag in response. To facilitate this, when setting up channels in the ACR system, the ACR system can be manually (e.g., by a human operator) or automatically (e.g., by a computing system running program logic) provisioned, and then subsequently updated, with information that indicates which of the channels are content-modification-enabled channels and which are not.

In response to identifying the second content-presentation device as discussed above, the content-management system 108 can then cause a replacement advertisement segment associated with the first advertisement segment to be transmitted to the second content-presentation device for output by the second content-presentation device in place of a modifiable advertisement segment in connection with an upcoming content-replacement opportunity on the content-modification-enabled channel to which the second content-presentation device is tuned. The second content-presentation device can then download the replacement advertisement segment and output the replacement advertisement segment in place of the modifiable advertisement segment. In some cases, the replacement can be performed with respect to another type of modifiable content-segment, such as a replaceable television program segment.

By way of example, the act of causing the replacement advertisement segment to be transmitted to the second content-presentation device can involve transmitting, to the supplemental-content delivery system 112, a request for a link pointing to the hosted replacement advertisement segment, and then transmitting the link to the second content-presentation device.

The content-management system 108 can select the replacement advertisement in various ways. As an example, the content-management system 108 can select the replacement advertisement segment to be the exact same (e.g., the same Ad-ID) as the first advertisement segment, thus exposing the second content-presentation device to the same advertisement to which the first content-presentation device was exposed.

As another example, it can be desirable in some situations to provide a replacement advertisement segment that is different from the first advertisement segment, but that includes or references the same good (e.g., product), service, event, or other advertised content as the first advertisement segment. In some cases, the replacement advertisement segment can be an entirely different advertisement for the same product. In other cases, the replacement advertisement segment can be a shortened version of the first advertisement segment, thus making it the same underlying advertisement, but a different segment in the sense that it is shorter in duration. For instance, the first advertisement segment can be a 45-second advertisement for a product and the replacement advertisement can be a 30-second version of the same advertisement (e.g., with 15 seconds cut, so as to accommodate a 30-second commercial time-slot). The replacement advertisement segment can be different from the first advertisement segment in other ways as well.

The content-management system 108 can use various selection criteria to select the replacement advertisement segment. For example, the content-management system 108 can access the broadcast schedule data or other types of data or metadata, any of which might be or include an identifier of the good, service, event, or other advertised content from the first advertisement segment and/or other identifiers associated with the first advertisement segment. The content-management system 108 can then use such identifier(s) from the data or metadata as selection criteria in selecting which replacement advertisement segment to provide to the second content-presentation device. In some situations, the content-management system 108 can receive such data or metadata from advertisers along with copies of the advertisements themselves, and can store the data or metadata in local or remote memory.

As a more specific example, the content-management system 108 can receive from a first advertiser a first set of advertisement segments each associated with a first product and a second set of advertisement segments each associated with a second product. The content-management system 108 can also receive, for each advertisement segment, corresponding metadata that includes (i) an Ad-ID, (ii) an identifier of the good, service, event, etc., (iii) a duration of the advertisement segment, (iv) a title or other short summary of the content that is part of the advertisement segment, (v) a text description of the content that is part of the advertisement segment, and/or (vi) one or more other identifiers, such as those that identify other notable aspects of the advertisement segment (e.g., a target demographic, such as a particular age group, gender, etc.). Other example metadata is possible as well.

The content-management system 108 can use other criteria as well to select the replacement advertisement segment, additionally or alternatively to the good, service, event, or other advertised content of the first advertisement segment. For example, the content-management system 108 can use historical content consumption data associated with the second content-presentation device to determine demographic data (e.g., gender, age group, etc.) expected to represent an end-user of the second content-presentation device. Demographic data that is typically accessible to the content-management system 108 can, in some situations, only provide demographic data about the household in its entirety. However, by accessing the historical content consumption data (e.g., the past content-viewing behavior) on a per-content-presentation device basis, the content-management system 108 can estimate individual demographic data for each of one or more end-users of that content-presentation device (as opposed to demographics of the household as a whole). The content-management system 108 can also use at least that demographic data as a basis to select the replacement advertisement segment.

For instance, the first content-presentation device may have received an advertisement for a sports car, particularly an advertisement that is particularly targeted to male end-users. If the content-management system 108 determines (e.g., using viewing behavior, such as a content-segment identifier of the content-segments recently received by the second content-presentation device) that the second content-presentation device is likely currently being viewed and/or is likely to have been historically viewed by a female end-user, the content-management system 108 can select a replacement advertisement segment for the same sports car that is targeted to female end-users.

In some examples, the content-management system 108 can use user account information associated with the second content-presentation device to help determine which specific end-user is expected to be currently watching the second content-presentation device. The content-management system 108 can then use demographic data and/or other historical content consumption data associated with that specific end-user as a basis for selecting the replacement advertisement segment.

By using demographic data as discussed above, the content-management system 108 can provide more-targeted advertisements to the second content-presentation device.

To help control the timing of the second content-presentation device's output of the replacement advertisement, the content-management system 108 can select, or facilitate selection of, the upcoming content-replacement opportunity. The content-management system 108 can then instruct the second content-presentation device to perform the replacement at the modification start-time of the selected opportunity. The timing for the second content-presentation device performing the replacement can thus vary based on which opportunity is selected.

As an example, the content-management system 108 can select an upcoming content-replacement opportunity based on a determination that the upcoming content-replacement opportunity has a modification start-time that is within a predefined time-window relative to the first content-presentation device receiving the first advertisement segment (e.g., within 1 to 15 seconds of the first content-presentation device receiving the first advertisement segment, or within a different time-window, such as within 15 to 30 seconds or 30 to 60 seconds). To determine when the first content-presentation device received the first advertisement segment, for instance, the content-management system 108 can refer to a receipt time-stamp of the first advertisement segment, determined by the first content-presentation device.

As another example, if the first content-presentation device recently received the first advertisement segment, it can be desirable to have the second content-presentation device present the replacement advertisement segment at the next possible content-replacement opportunity. The content-management system 108 can thus instruct the second content-presentation device to perform the replacement at its next possible content-replacement opportunity.

To account for a situation where the second content-presentation device changes channels, the content-management system 108 can instruct the second content-presentation device to perform the replacement at the next possible content-replacement opportunity on whichever channel the second content-presentation device tuned to, so long as the content-management system 108 (or the second content-presentation device itself) determines that channel to be a content-modification-enabled channel.

In some examples, even if the second content-presentation device is not currently tuned to a content-modification-enabled channel, the content-management system 108 can still cause the replacement advertisement segment to be transmitted to the second content-presentation device, along with an instruction for the second content-presentation device to use the replacement advertisement segment at the next possible content-replacement opportunity that the second content-presentation device has whenever the second content-presentation device tunes to a content-modification-enabled channel.

With respect to households that include more than two content-presentation devices, the “second content-presentation device” discussed herein in connection with the disclosed operations can be representative of one of the multiple other content-presentation devices of the household, different from the first content-presentation device. In line with this, the act of identifying the second content-presentation device can involve identifying, from the identified group, a set of one or more content-presentation devices, including the second content-presentation device, that are different from the first content-presentation device and that are each tuned to content-modification-enabled channels. That is, the content-management system 108 can determine which of the other content-presentation devices of the household are tuned to a content-modification-enabled channel.

The content-modification-enabled channel to which a given one of the set of content-presentation devices is tuned can be the same channel on which the first content-presentation device received the first advertisement segment, or can be a different channel. Further, two or more of the set of content-presentation devices can be tuned to different content-modification-enabled channels in some situations. The content-management system 108 can identify each such content-presentation device in the same manner as discussed above or in a different manner.

In a situation in which the content-management system 108 has identified a set of content-presentation devices of the household that are each tuned to content-modification-enabled channels, the content-management system 108 can, for each content-presentation device of the identified set, cause a respective replacement advertisement segment associated with the first advertisement segment to be transmitted to that content-presentation device. Each such content-presentation device can then output that respective replacement advertisement in place of a modifiable advertisement segment in connection with an upcoming content-replacement opportunity on the respective content-modification-enabled channel to which that content-presentation device is tuned. For example, if there are three other content-presentation devices in a household that are each tuned to a content-modification-enabled channel, the content-management system 108 can select, for each of the three content-presentation devices, a respective replacement advertisement segment. The respective replacement advertisement segments could all be the same, or two or more of such advertisement segments could be different form each other. The content-management system 108 can then cause the selected replacement advertisement segments to be transmitted to the respective content-presentation devices, perhaps along with an instruction for the respective content-presentation devices to perform a replacement at the next possible content-replacement opportunity each content-presentation device has.

To help simultaneously or near-simultaneously expose two or more content-presentation devices of the identified set to the same or similar advertisement segment, the content-management system 108 can compare respective modification start-times for the content-presentation devices. The comparison can then be used to coordinate the output of the advertisement segment(s).

For example, the content-management system 108 can determine that the second content-presentation device has two upcoming content-replacement opportunities on a current channel, one at 02:00:00 PM and another at 02:05:30 PM. Further, the content-management system 108 can also determine that a third content-presentation device of the identified set has two upcoming content-replacement opportunities on a current channel, one at 02:01:00 PM and another at 02:05:30 PM.

Assuming that the content-management system 108 plans to have the second and third content-presentation device each output the same replacement advertisement segment, a car commercial, the content-management system 108 could be configured to prioritize each content-presentation device outputting the car commercial at the next possible opportunity, which would be the 02:00:00 PM modification start-time for the second content-presentation device and the 02:01:00 PM modification start-time for the third content-presentation device. Alternatively, the content-management system 108 could be configured to prioritize simultaneous exposure of the car commercial over exposing each content-presentation device at the next possible opportunity. To do this, the content-management system 108 can compare the above-noted modification start-times with each other and determine that two of the modification start-times match. The content-management system 108 can thus select the 02:05:30 PM modification start-time to be the content-replacement opportunity start-time for the second and third content-presentation devices to output the car commercial, and instruct the second and third content-presentation devices accordingly.

As a variation on the above-described example, the content-management system 108 can, in some cases, take into account how close in time the modification start-times are when comparing them. For example, the content-management system 108 can be configured to prioritize simultaneous or near-simultaneous exposure of the car commercial to the second and third content-presentation devices unless the modification start-times do not fall within the same predefined time-window (e.g., the first 120-second commercial break of a program segment) or are greater than a predefined threshold time-period apart from one another (e.g., more than 15 seconds apart). Other examples and example thresholds are possible as well.

In additional embodiments, the act of causing the replacement advertisement segment associated with the first advertisement segment to be transmitted to the second content-presentation device can be performed further in response to a determination that at least a threshold percentage (e.g., at least 50%) or threshold number (e.g., at least three) of the content-presentation devices in the household are tuned to content-modification-enabled channels. In some examples, the threshold percentage can be 100% and the threshold number can be all of the content-presentation devices.

Furthermore, in the above-described examples, if a particular one of the content-presentation devices of the household is not tuned to a content-modification-enabled channel, the content-management system 108 can cause each of the other content-presentation devices that are tuned to a content-modification-enabled channel to perform the above-described replacements with respective replacement advertisement segments. In other situations, however, if the threshold percentage or threshold number is not met or exceeded, the content-management system 108 might be configured to not provide the replacement advertisement segment to the other content-presentation devices.

In alternative embodiments, other considerations, different from the consideration of whether the first content-presentation device has received the first advertisement segment, can be used to trigger transmission of replacement advertisement segment(s) to other content-presentation devices of the household.

As an example, after identifying the group of content-presentation devices that are associated with the same household, the content-management system 108 can determine whether at least a threshold percentage of the content-presentation devices in the identified group are tuned to content-modification-enabled channels. In some cases, the threshold percentage can be 100% of the content-presentation devices of the household. In other cases, the threshold percentage can be a percentage that is less than 100% (e.g., 75%).

In response to determining that at least the threshold percentage of the content-presentation devices in the identified group are tuned to content-modification-enabled channels, the content-management system 108 can, for each content-presentation device that is tuned to a respective content-modification-enabled channel, cause a respective replacement advertisement segment to be transmitted to that content-presentation device for output by that content-presentation device in place of a modifiable advertisement segment in connection with an upcoming content-replacement opportunity on the respective content-modification-enabled channel to which that content-presentation device is tuned. In particular, the content-management system 108 can select the respective replacement advertisement segments such that the respective replacement advertisement segments are associated with each other. Selection of the respective replacement advertisement segments can be performed in various ways, including but not limited to any of the ways described above.

For example, the content-management system 108 can select the same replacement advertisement segment to be transmitted to each content-presentation device for the content-presentation device to output at its next possible content-replacement opportunity, so as to cause all (or less than all, depending on what the threshold percentage is) of the content-presentation devices of the household to output that same replacement advertisement segment.

As another example, the content-management system 108 can select the respective replacement advertisement segments such that two or more of the respective replacement advertisement segments are different from each other, but each include or reference the same good, service, event, or other advertised content as each other.

In some situations, the second content-presentation device may already have stored in its local memory a replacement advertisement segment that is associated with the first advertisement segment or otherwise suitable for use in the herein-described replacement. As such, instead of causing the replacement advertisement segment to be transmitted to the second content-presentation device, the content-management system 108 can instruct the second content-presentation device to use the replacement advertisement segment stored in the local memory.

As a result of the above-described operations, exposure of an advertisement segment to multiple different content-presentation devices of the household can be achieved, including in situations where not all content-presentation devices of the household are tuned to the same channel. Further, the exposure to the multiple different content-presentation devices can be simultaneous, near-simultaneous, or occur within another predefined time-window of each other, such as minutes, hours, or within the same daypart.

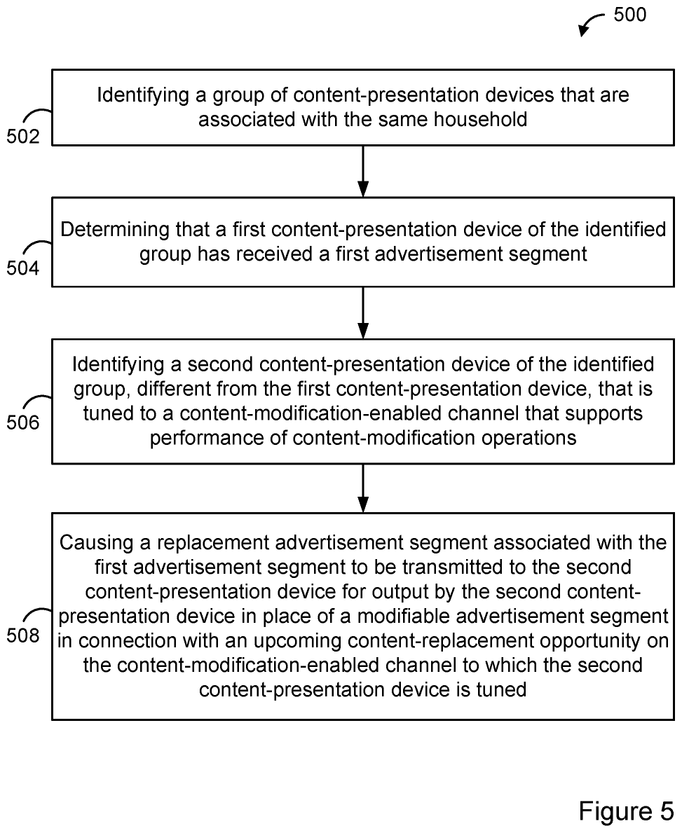

FIG. 5 is a flow chart of an example method 500. At block 502, the method 500 includes identifying a group of content-presentation devices that are associated with the same household.

At block 504, the method 500 includes determining that a first content-presentation device of the identified group has received a first advertisement segment.

At block 506, the method 500 includes identifying a second content-presentation device of the identified group, different from the first content-presentation device, that is tuned to a content-modification-enabled channel that supports performance of content-modification operations.

At block 508, the method 500 includes causing a replacement advertisement segment associated with the first advertisement segment to be transmitted to the second content-presentation device for output by the second content-presentation device in place of a modifiable advertisement segment in connection with an upcoming content-replacement opportunity on the content-modification-enabled channel to which the second content-presentation device is tuned.

In some embodiments, the replacement advertisement segment can include or reference the same good, service, event, or other advertised content as the first advertisement segment. In some cases, the replacement advertisement segment can be the same as the first advertisement segment. In other cases, the replacement advertisement segment can be different from the first advertisement segment.

In some embodiments, the method 500 can also include before causing the replacement advertisement segment to be transmitted to the second content-presentation device: using historical content consumption data associated with the second content-presentation device to determine demographic data expected to represent an end-user of the second content-presentation device, and selecting the replacement advertisement segment based at least in part on the determined demographic data.

In some embodiments, the method 500 can also include selecting the upcoming content-replacement opportunity based on the upcoming content-replacement opportunity having a modification start-time that is within a predefined time-window relative to the first content-presentation device receiving the first advertisement segment.

In some embodiments, the act of identifying the second content-presentation device comprises identifying, from the identified group, a set of one or more content-presentation devices, including the second content-presentation device and different from the first content-presentation device, that are each tuned to content-modification-enabled channels. Further, the method 500 can also include determining that the identified set makes up at least a threshold percentage of the content-presentation devices in the identified group. Still further, the act of causing the replacement advertisement associated with the first advertisement segment to be transmitted to the second content-presentation device can be performed in response to determining that the identified set makes up at least the threshold percentage of the content-presentation devices in the identified group.

Although the above-described operations primarily relate to replacing modifiable content-segments with replacement advertisement segments, it should be understood that the above-described operations could be carried out additionally or alternatively with respect to other content-modification operations, such as content-overlay operations. By way of example, in response to determining that the first content-presentation device has received a first advertisement segment, and/or first advertisement overlay that is overlaid over an underlying content segment, the content-management system 108 can identify a second content-presentation device of the identified group that is tuned to a content-modification-enabled channel and select an advertisement overlay that is associated with the first advertisement segment and/or the first advertisement overlay. The content-management system 108 can then cause the selected advertisement overlay to be transmitted to the second content-presentation device for output by the second content-presentation device in connection with an upcoming content-replacement opportunity on the content-modification-enabled channel to which the second content-presentation device is tuned. Other examples are possible as well.

### IV. Example Variations

Although the examples and features described above have been described in connection with specific entities and specific operations, in practice, there are likely to be many instances of these entities and many instances of these operations being performed, perhaps contemporaneously or simultaneously, on a large-scale basis. Indeed, in practice, the content-modification system 100 is likely to include many content-distribution systems (each potentially transmitting content on many channels) and many content-presentation devices, with some or all of the described operations being performed on a routine and repeating basis in connection with some or all of these entities.

In addition, although some of the operations described in this disclosure have been described as being performed by a particular entity, the operations can be performed by any entity, such as the other entities described in this disclosure. Further, although the operations have been recited in a particular order and/or in connection with example temporal language, the operations need not be performed in the order recited and need not be performed in accordance with any particular temporal restrictions. However, in some instances, it can be desired to perform one or more of the operations in the order recited, in another order, and/or in a manner where at least some of the operations are performed contemporaneously/simultaneously. Likewise, in some instances, it can be desired to perform one or more of the operations in accordance with one more or the recited temporal restrictions or with other timing restrictions. Further, each of the described operations can be performed responsive to performance of one or more of the other described operations. Also, not all of the operations need to be performed to achieve one or more of the benefits provided by the disclosure, and therefore not all of the operations are required.

Although certain variations have been described in connection with one or more examples of this disclosure, these variations can also be applied to some or all of the other examples of this disclosure as well and therefore aspects of this disclosure can be combined and/or arranged in many ways. The examples described in this disclosure were selected at least in part because they help explain the practical application of the various described features.

Also, although select examples of this disclosure have been described, alterations and permutations of these examples will be apparent to those of ordinary skill in the art. Other changes, substitutions, and/or alterations are also possible without departing from the invention in its broader aspects as set forth in the following claims.

What is claimed is:

1. A method comprising:
identifying a group of content-presentation devices that are associated with the same household;
determining that a first content-presentation device of the identified group has received a first advertisement segment;
identifying a second content-presentation device of the identified group, different from the first content-presentation device, that is tuned to a content-modification-enabled channel that supports performance of content-modification operations; and
causing a replacement advertisement segment associated with the first advertisement segment to be transmitted to the second content-presentation device for output by the second content-presentation device in place of a modifiable advertisement segment in connection with an upcoming content-replacement opportunity on the content-modification-enabled channel to which the second content-presentation device is tuned.

2. The method of claim 1, wherein the replacement advertisement segment includes or references the same good, service, event, or other advertised content as the first advertisement segment.

3. The method of claim 2, wherein the replacement advertisement segment is the same as the first advertisement segment.

4. The method of claim 2, wherein the replacement advertisement segment is different from the first advertisement segment.

5. The method of claim 1, further comprising:
before causing the replacement advertisement segment to be transmitted to the second content-presentation device:
using historical content consumption data associated with the second content-presentation device to determine demographic data expected to represent an end-user of the second content-presentation device; and
selecting the replacement advertisement segment based at least in part on the determined demographic data.

6. The method of claim 1, further comprising:
selecting the upcoming content-replacement opportunity based on the upcoming content-replacement opportunity having a modification start-time that is within a predefined time-window relative to the first content-presentation device receiving the first advertisement segment.

7. The method of claim 1, wherein identifying the second content-presentation device comprises identifying, from the identified group, a set of one or more content-presentation devices, including the second content-presentation device and different from the first content-presentation device, that are each tuned to content-modification-enabled channels, the method further comprising:
determining that the identified set makes up at least a threshold percentage of the content-presentation devices in the identified group,
wherein causing the replacement advertisement associated with the first advertisement segment to be transmitted to the second content-presentation device is performed in response to determining that the identified set makes up at least the threshold percentage of the content-presentation devices in the identified group.

8. A non-transitory computer-readable storage medium, having stored thereon program instructions that, upon execution by a processor, cause performance of a set of operations comprising:
identifying a group of content-presentation devices that are associated with the same household;
determining that a first content-presentation device of the identified group has received a first advertisement segment;
identifying a second content-presentation device of the identified group, different from the first content-presentation device, that is tuned to a content-modification-enabled channel that supports performance of content-modification operations; and
causing a replacement advertisement segment associated with the first advertisement segment to be transmitted to the second content-presentation device for output by the second content-presentation device in place of a modifiable advertisement segment in connection with an upcoming content-replacement opportunity on the content-modification-enabled channel to which the second content-presentation device is tuned.

9. The non-transitory computer-readable storage medium of claim 8, wherein the replacement advertisement segment includes or references the same good, service, event, or other advertised content as the first advertisement segment.

10. The non-transitory computer-readable storage medium of claim 9, wherein the replacement advertisement segment is the same as the first advertisement segment.

11. The non-transitory computer-readable storage medium of claim 9, wherein the replacement advertisement segment is different from the first advertisement segment.

12. The non-transitory computer-readable storage medium of claim 8, the set of operations further comprising:
before causing the replacement advertisement segment to be transmitted to the second content-presentation device:
using historical content consumption data associated with the second content-presentation device to determine demographic data expected to represent an end-user of the second content-presentation device; and
selecting the replacement advertisement segment based at least in part on the determined demographic data.

13. The non-transitory computer-readable storage medium of claim 8, the set of operations further comprising:
selecting the upcoming content-replacement opportunity based on the upcoming content-replacement opportunity having a modification start-time that is within a predefined time-window relative to the first content-presentation device receiving the first advertisement segment.

14. The non-transitory computer-readable storage medium of claim 8, wherein identifying the second content-presentation device comprises identifying, from the identified group, a set of one or more content-presentation devices, including the second content-presentation device and different from the first content-presentation device, that are each tuned to content-modification-enabled channels, the set of operations further comprising:
determining that the identified set makes up at least a threshold percentage of the content-presentation devices in the identified group,
wherein causing the replacement advertisement associated with the first advertisement segment to be transmitted to the second content-presentation device is performed in response to determining that the identified set makes up at least the threshold percentage of the content-presentation devices in the identified group.

15. A computing system comprising:
a processor; and
a non-transitory computer-readable storage medium, having stored thereon program instructions that, upon execution by the processor, cause performance of a set of operations comprising:
identifying a group of content-presentation devices that are associated with the same household;
determining that a first content-presentation device of the identified group has received a first advertisement segment;
identifying a second content-presentation device of the identified group, different from the first content-presentation device, that is tuned to a content-modification-enabled channel that supports performance of content-modification operations; and
causing a replacement advertisement segment associated with the first advertisement segment to be transmitted to the second content-presentation device for output by the second content-presentation device in place of a modifiable advertisement segment in connection with an upcoming content-replacement opportunity on the content-modification-enabled channel to which the second content-presentation device is tuned.

16. The computing system of claim 15, wherein the replacement advertisement segment includes or references the same good, service, event, or other advertised content as the first advertisement segment.

17. The computing system of claim 16, wherein the replacement advertisement segment is the same as the first advertisement segment.

18. The computing system of claim 16, wherein the replacement advertisement segment is different from the first advertisement segment.

19. The computing system of claim 15, the set of operations further comprising:
before causing the replacement advertisement segment to be transmitted to the second content-presentation device:
using historical content consumption data associated with the second content-presentation device to determine demographic data expected to represent an end-user of the second content-presentation device; and
selecting the replacement advertisement segment based at least in part on the determined demographic data.

20. The computing system of claim 15, the set of operations further comprising:
selecting the upcoming content-replacement opportunity based on the upcoming content-replacement opportunity having a modification start-time that is within a predefined time-window relative to the first content-presentation device receiving the first advertisement segment.
